(19) United States
(12) Patent Application Publication
(10) Pub. No.: US 2015/0106581 A1
(43) Pub. Date: Apr. 16, 2015

(54) STORAGE MANAGEMENT DEVICE, INFORMATION PROCESSING SYSTEM, STORAGE MANAGEMENT METHOD, AND RECORDING MEDIUM

(71) Applicant: FUJITSU LIMITED, Kawasaki-shi (JP)

(72) Inventor: MASARU SHIMMITSU, Kawasaki (JP)

(21) Appl. No.: 14/477,185

(22) Filed: Sep. 4, 2014

(30) Foreign Application Priority Data
Oct. 15, 2013 (JP) 2013215112

(51) Int. Cl. G06F 3/06

(52) U.S. Cl. CPC G06F 3/065; G06F 3/0619; G06F 3/067
USPC 711/162

(57) ABSTRACT

A storage management device includes: a memory; and a processor coupled to the memory. The processor executes a process including: managing a plurality of storages in a system in which a data storage destination is switched between a first storage and a second storage; first performing management to cause the first storage to hold data as master data and cause the second storage to hold data equivalent to the master data as backup data; and second performing management to cause the second storage to hold update data for the backup data held in the second storage independently from the backup data and cause a third storage different from the first storage and the second storage to duplicate the update data when the data storage destination is switched from the first storage to the second storage.

### CROSS-REFERENCE TO RELATED APPLICATION

This application is based upon and claims the benefit of priority of the prior Japanese Patent Application No. 2013-215112, filed on Oct. 15, 2013, the entire contents of which are incorporated herein by reference.

### FIELD

The embodiments discussed herein are related to a storage management device and the like.

### BACKGROUND

In recent years, a virtualization technology which operates a virtual machine on a physical server is used. For example, in a data center, environments in which a virtual machine is operated on a physical server by using a virtualization program are increasing. The virtualization program has a function to transfer a virtual machine operating on a physical machine to a physical server of another data center. Such a transfer of the virtual machine is referred to as “migration”.

Regarding the migration, there is a technique that manages the transfer of the virtual machines according to load states of virtual machines when operating the data center (for example, see Japanese Laid-open Patent Publication No. 2006-174609). In this technique, for example, a virtual machine operating on a physical server on which the number of operating virtual machines is the smallest is to be stopped. Further, a transfer destination of a virtual machine is controlled so that data centers whose load variations are similar to each other are collected on the same physical server.

Patent Document 1: Japanese Laid-open Patent Publication No. 2006-174609

Patent Document 2: Japanese Laid-open Patent Publication No. 2011-90594

By the way, a virtual disk is arranged for a virtual machine in a data center. Redundancy is implemented in the virtual disk, so that the virtual disk has the same capacity for a virtual machine in each data center. For example, if there are three data centers, the total capacity of the virtual disks for the virtual machines is three times the capacity of the virtual disk for the virtual machines.

However, if the capacity of three times the capacity of the virtual disk is prepared for the virtual machines, there is a problem that the total capacity of the virtual disks of the entire system increases when data of the virtual machines are updated.

### SUMMARY

According to an aspect of the embodiments, a storage management device includes: a memory; and a processor coupled to the memory. The processor executes a process including: managing a plurality of storages in a system in which a data storage destination is switched between a first storage and a second storage; first performing management to cause the first storage to hold data as master data and cause the second storage to hold data equivalent to the master data as backup data; and second performing management to cause the second storage to hold update data for the backup data held in the second storage independently from the backup data and cause a third storage different from the first storage and the second storage to duplicate the update data when the data storage destination is switched from the first storage to the second storage.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a hardware configuration of an information processing system according to an embodiment;

FIG. 2A is a diagram illustrating a functional configuration of a data center according to the embodiment;

FIG. 2B is a diagram illustrating an example of functional configuration of a management unit according to the embodiment;

FIG. 3A is a diagram illustrating a case in which DCs of a master storage and a backup storage operate;

FIG. 3B is a diagram illustrating a case in which DCs of a backup storage and a reserve storage operate;

FIG. 3C is a diagram illustrating a case in which DCs of a master storage and a reserve storage operate;

FIG. 4A is a diagram illustrating a case in which VM is transferred from a master storage to a backup storage;

FIG. 4B is a diagram illustrating a case in which VM is transferred from a backup storage to a master storage;

FIG. 5 is a diagram illustrating a relationship between a virtual machine and a storage destination volume;

FIG. 6A is a diagram illustrating an example of a data structure of a storage status table;

FIG. 6B is a diagram illustrating an example of a data structure of a DC power status table;

FIG. 6C is a diagram illustrating an example of a data structure of a DC basic power amount table;

FIG. 7A is a diagram illustrating a sequence of a DC management process according to the embodiment;

FIG. 7B is a diagram illustrating a sequence of the DC management process according to the embodiment;

FIG. 7C is a diagram illustrating a sequence of the DC management process according to the embodiment;

FIG. 7D is a diagram illustrating a sequence of the DC management process according to the embodiment;

FIG. 8A is a diagram illustrating a sequence of an introduction setting process;

FIG. 8B is a diagram illustrating a sequence of the introduction setting process;

FIG. 8C is a diagram illustrating a sequence of the introduction setting process;

FIG. 8D is a diagram illustrating a sequence of the introduction setting process;

FIG. 9A is a diagram illustrating a sequence of a DC power cost comparison process;

FIG. 9B is a diagram illustrating a sequence of the DC power cost comparison process;

FIG. 10A is a diagram illustrating a sequence of a master storage transfer process;

FIG. 10B is a diagram illustrating a sequence of the master storage transfer process;

FIG. 10C is a diagram illustrating a sequence of the master storage transfer process;

FIG. 10D is a diagram illustrating a sequence of the master storage transfer process;

FIG. 11A is a diagram illustrating a sequence of a backup storage transfer process;

FIG. 11B is a diagram illustrating a sequence of the backup storage transfer process;

FIG. 11C is a diagram illustrating a sequence of the backup storage transfer process;

FIG. 11D is a diagram illustrating a sequence of the backup storage transfer process;

FIG. 11E is a diagram illustrating a sequence of the backup storage transfer process;

FIG. 11F is a diagram illustrating a sequence of the backup storage transfer process; and

FIG. 12 is a diagram illustrating a hardware configuration of a management server that executes a DC management program.

### DESCRIPTION OF EMBODIMENTS

Preferred embodiments will be explained with reference to accompanying drawings. The present embodiment is applied to an information processing system including a plurality of data centers that provide virtual machines. The invention is not limited by the present embodiment. The each embodiment can be appropriately combined in a range where processing contents are not inconsistent with each other.

Configuration of the Information Processing System According to the Embodiment

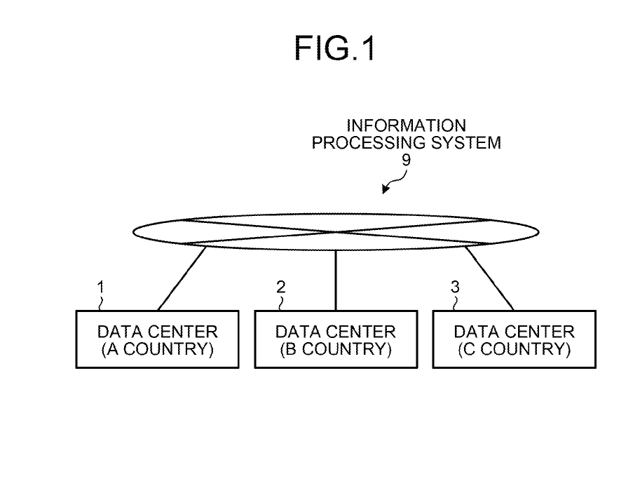

FIG. 1 is a diagram illustrating a hardware configuration of the information processing system according to the embodiment. As illustrated in FIG. 1, an information processing system 9 includes a plurality of data centers 1, 2, and 3. The plurality of data centers 1, 2, and 3 are connected to each other by a network. The network may be, but need not be, a dedicated line. The information processing system 9 is a system in which a data storage destination can be switched between a first storage mounted in one data center and a second storage mounted in another data center among the data centers 1, 2, and 3 regarding a transferable virtual machine (VM). The plurality of data centers 1, 2, and 3 are installed respectively in areas whose daylight hours are different from each other, that is, areas whose power costs are different from each other at the same time point. The information processing system 9 transfers VM and switches a storage destination of data of the VM according to, for example, the power costs at the same time point. In the embodiment, the data centers 1, 2, and 3 are installed in A country, B country, and C country, respectively, as examples of areas whose daylight hours are different from each other.

Hardware Configuration of Data Center

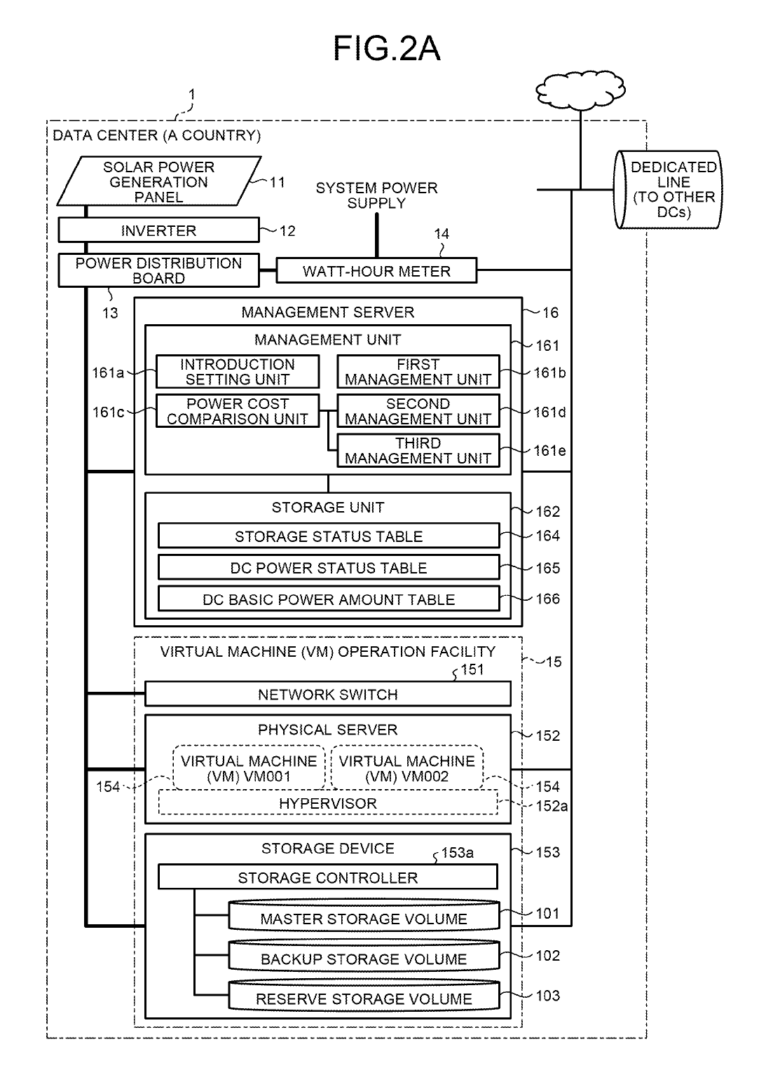

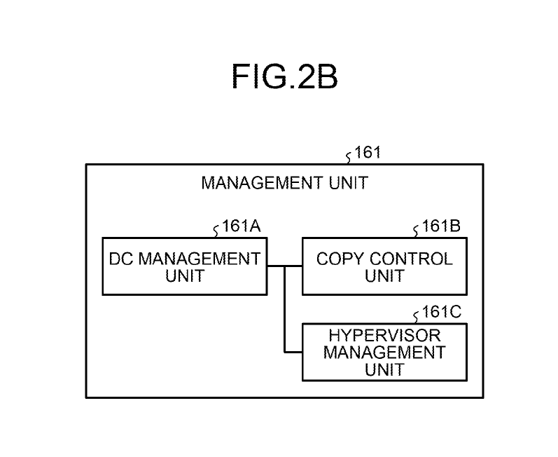

Next, a functional configuration of the data center 1 will be described with reference to FIG. 2A. FIG. 2A is a diagram illustrating a functional configuration of a data center according to the embodiment. The functional configurations of the data centers 2 and 3 are the same as that of the data center 1, so that descriptions of the data centers 2 and 3 are omitted.

The data center 1 includes a solar power generation panel 11, an inverter 12, a power distribution board 13, a watt-hour meter 14, a virtual machine (VM) operation facility 15, and a management server 16.

The solar power generation panel 11 is a panel used to charge solar energy. Specifically, the data center 1 is operated by using power generated by the solar power generation panel 11. The inverter 12 electrically generates AC power from DC power. The power distribution board 13 performs switching between opening and closing of power distribution. The watt-hour meter 14 measures the amount of power.

The virtual machine (VM) operation facility 15 represents a base of infrastructure and is a facility used to operate VMs. The VM operation facility 15 includes a network switch 151, a physical server 152, and a storage device 153. The physical server 152 causes a plurality of virtual machines (VM001 and VM002) 154 to operate on a hypervisor 152a by executing a server virtualization program.

The storage device 153 includes a storage controller 153a, a master storage volume 101, a backup storage volume 102, and a reserve storage volume 103. The storage controller 153a controls the master storage volume 101, the backup storage volume 102, and the reserve storage volume 103, which are storages.

A predetermined role as a storage is assigned to the master storage volume 101, the backup storage volume 102, and the reserve storage volume 103 for each VM. A role as a master storage is assigned to the master storage volume 101. The master storage is a storage to which a storage area of a virtual disk of a VM is assigned. It is possible to update data of the virtual disk. A role as a backup storage is assigned to the backup storage volume 102. The backup storage is a storage to which a storage area of a virtual disk in which data of a virtual disk of the master storage is duplicated and a storage area in which difference data that is updated after the duplication is stored are assigned. It is not possible to update a duplicated virtual disk. A role as a reserve storage is assigned to the reserve storage volume 103. The reserve storage is a storage to which a storage area in which difference data generated in a virtual disk is stored is assigned. Specifically, for one VM, for example, a storage device of a first data center plays a role as the master storage, a storage device of a second data center plays a role as the backup storage, and a storage device of a third data center plays a role as the reserve storage. The data center that plays a role of the master storage is a base that mainly uses VM. The roles assigned to each storage for one VM are assigned by, for example, a system administrator.

The management server 16 manages a plurality of storages in the information processing system 9. The management server 16 has a master-slave relationship with management servers 26 and 36 of the other DCs 2 and 3. The master-slave relationship between the management servers is set by an administrator in advance. A master management server notifies a command related to an operation of DC to a management server of another DC. A slave management server executes activation and stop of equipment included in DC, VM, and remote copy of storage device according to the command. The master management server of the master-slave relationship is referred to as a “lead”. In the description below, the management server 16 of DC 1 is referred to as the “lead”.

The management server 16 includes a management unit 161 and a storage unit 162. The management unit 161 includes an introduction setting unit 161a, a first management unit 161b, a power cost comparison unit 161c, a second management unit 161d, and a third management unit 161e. The management server 16 is an example of a storage management device. The introduction setting unit 161a is an example of an assignment unit. The power cost comparison unit 161c is an example of a calculation unit and a determination unit.

The introduction setting unit 161a assigns roles of a master storage, a backup storage, or a reserve storage to a transferable VM for each DC in advance. For example, when a DC in which a transferable VM plays a role as the master storage is set in advance, the introduction setting unit 161a sets DCs that play roles as the backup storage and the reserve storage respectively according to daylight hours. The DC that plays a role of the master storage is set by, for example, a system administrator.

The first management unit 161b performs management to cause the master storage to hold data as master data and cause the backup storage to hold data equivalent to the master data as backup data. For example, it is assumed that the DC 1 plays a role of the master storage and the DC 2 plays a role of the backup storage for a certain VM. The management server 16 of the DC 1 is the “lead”. The first management unit 161b updates data of the VM being operated in the DC 1 as master data into the master storage volume 101 in the DC 1. Then, the first management unit 161b remotely copies the updated data as backup data into a backup storage volume 202 of the DC 2 having data equivalent to the data before the update for the VM. Thereby, the first management unit 161b can make redundant to data for the VM in the master storage volume 101 and the backup storage volume 202.

The power cost comparison unit 161c compares the power costs of the DCs 1, 2, and 3. Then, the power cost comparison unit 161c determines whether or not the power cost of the DC in which the VM is being operated is higher than the power cost of a transfer destination DC in a case in which the VM is transferred to the transfer destination DC based on the calculated power costs. As a result of the determination, when it is determined that the power cost of the DC in which the VM is being operated is higher than the power cost of a transfer destination DC in a case in which the VM is transferred to the transfer destination DC, the power cost comparison unit 161c performs the following processing: The power cost comparison unit 161c causes the second management unit 161d and the third management unit 161e described later to switch the storage destination of the data of the VM from the DC in which the VM is being operated to the transfer destination DC.

In other words, the power cost comparison unit 161c determines a DC where the power cost can be reduced by comparing the power costs of the DCs based on, for example, the amounts of solar power generation. Then, the power cost comparison unit 161c causes the second management unit 161d and the third management unit 161e to perform control so as to transfer the VM to the DC where the power cost can be reduced. In other words, the power cost comparison unit 161c causes the DC where the power cost can be reduced to be utilized to operate the VM and also to be utilized to store update data (hereinafter also referred to as “difference data”) that is updated by the VM.

When the data storage destination is switched from the master storage to the backup storage, the second management unit 161d performs management to cause the backup storage to hold update data for the backup data independently from the backup data. Further, the second management unit 161d performs management to cause the reserve storage to duplicate the update data. For example, it is assumed that the DC 1 plays a role of the master storage, the DC 2 plays a role of the backup storage, and the DC 3 plays a role of the reserve storage for a certain VM. The management server 16 of the DC 1 is the “lead”. When the data storage destination is switched from master storage volume 101 of the DC 1 to the backup storage volume 202 of the DC 2, the second management unit 161d stops the operation of the VM operation facility 15 of the DC 1 and transfers the VM from the DC 1 to the DC 2. The second management unit 161d causes an area independent from the backup data in the backup storage volume 202 to hold the update data for the backup storage volume 202 of the DC 2 as the difference data. Then, the second management unit 161d causes a reserve storage volume 303 of the DC 3 to remotely copy the update data as the reserve data. Thereby, for the VM, the update data (difference data) updated into the backup storage volume 202 is held in the reserve storage volume 303, so that the second management unit 161d can make redundant to the difference data.

When the data storage destination is switched from the backup storage to the master storage, the third management unit 161e performs management to cause the master storage to duplicate the update data duplicated in the reserve storage. For example, it is assumed that the DC 1 plays a role of the master storage, the DC 2 plays a role of the backup storage, and the DC 3 plays a role of the reserve storage for a certain VM. The management server 16 of the DC 1 is the “lead”. When the data storage destination is switched from the backup storage volume 202 of the DC 2 to the master storage volume 101 of the DC 1, the third management unit 161e stops the operation of the VM operation facility 25 of the DC 2 and transfers the VM from the DC 2 to DC 1 again. The third management unit 161e causes the master storage volume 101 to remotely copy the reserve data duplicated by the reserve storage volume 303. Thereby, when the VM is transferred again, the third management unit 161e can shorten the period of time to transfer the VM by copying only the difference data of the reserve storage to the master storage volume 101.

Here, an example of a diagram illustrating the function of the management unit 161 will be described with reference to FIG. 2B. FIG. 2B is a diagram illustrating an example of a functional configuration of the management unit according to the embodiment. As illustrated in FIG. 2B, the management unit 161 includes a DC management unit 161A realized by executing a DC management program, a copy control unit 161B realized by executing a copy control program, and a hypervisor management unit 161C realized by executing a hypervisor management program. The DC management unit 161A includes respective functions of the introduction setting unit 161a, the first management unit 161b, the power cost comparison unit 161c, the second management unit 161d, and the third management unit 161e.

The copy control unit 161B controls the remote copy of data between DCs. The copy control unit 161B is called by the DC management unit 161A. The hypervisor management unit 161C manages the hypervisor 152a. The hypervisor management unit 161C is called by the DC management unit 161A. The DC management program, the copy control program, and the hypervisor management program are stored in, for example, the storage unit 162.

The management server 16 includes a storage status table 164, a DC power status table 165, and a DC basic power amount table 166. The storage status table 164 stores roles of storages of each DC for the VM. The storage status table 164 further stores operation states of storages of each DC for the VM. The DC power status table 165 stores information used to calculate the power cost of DC for each DC. The DC basic power amount table 166 stores the basic power amount according the number of physical servers for each DC. The details of data structures of the storage status table 164, the DC power status table 165, and the DC basic power amount table 166 will be described later.

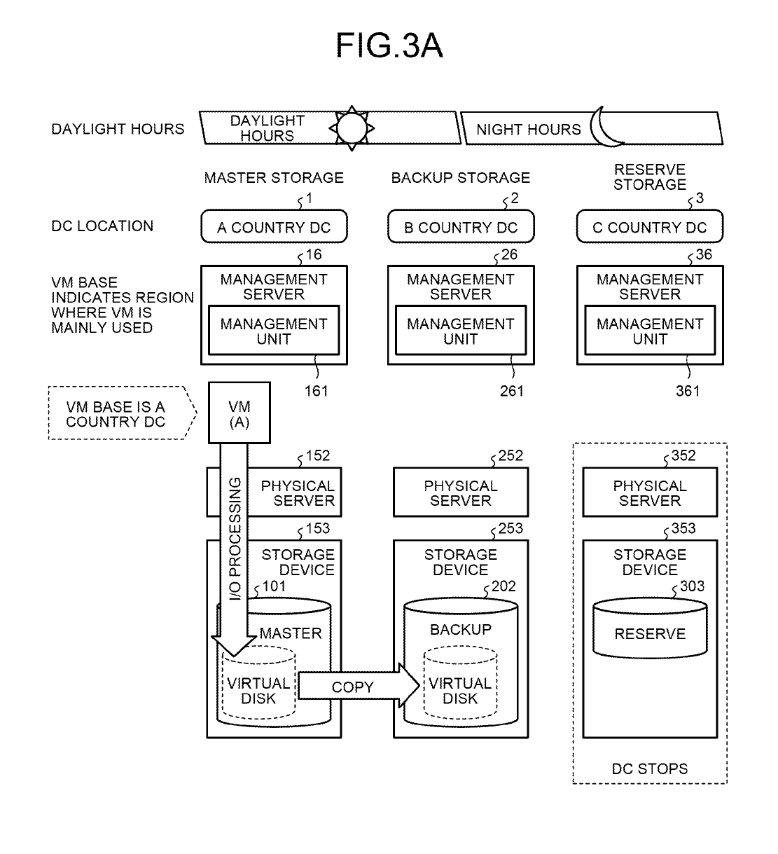

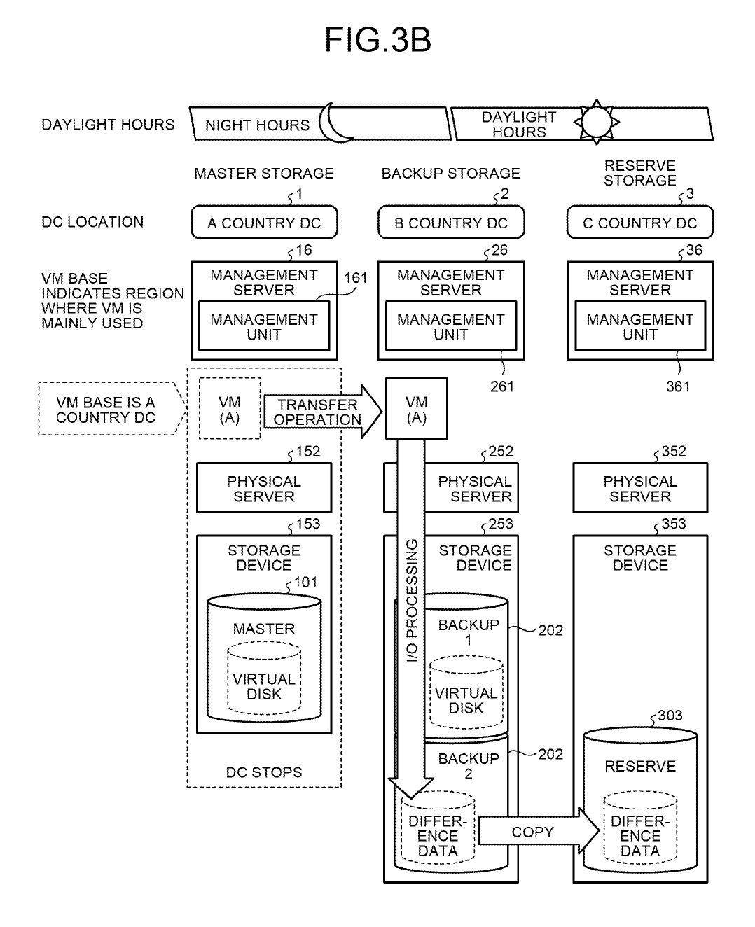

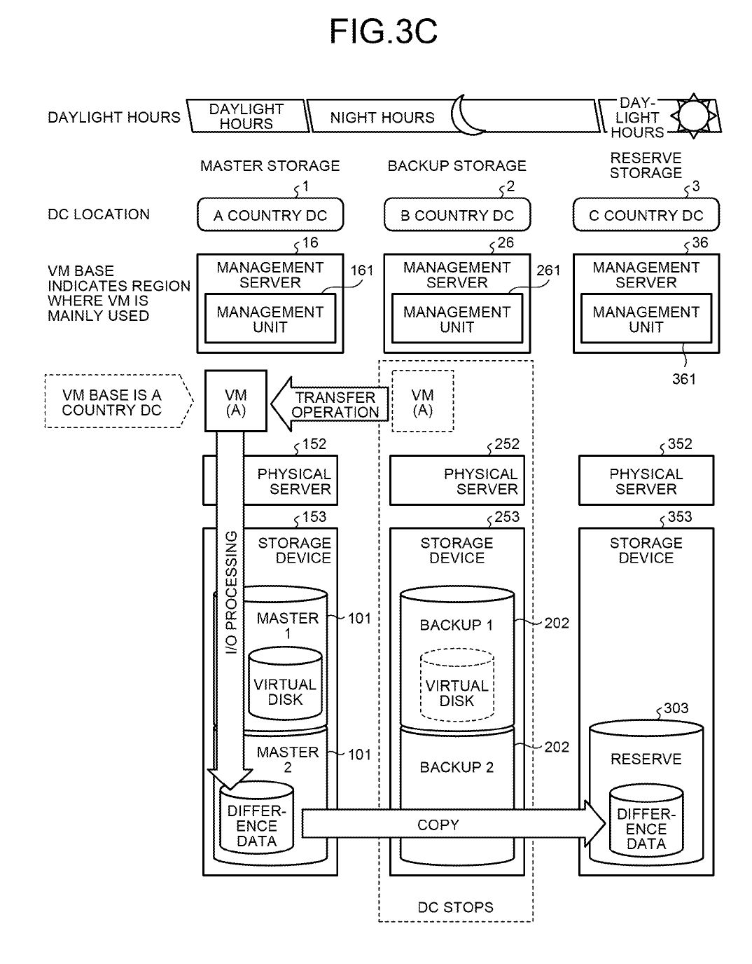

Here, the relationship between the roles of storages and the storage destinations of data processed by the VM will be described with reference to FIGS. 3A to 3C. FIG. 3A is a diagram illustrating a case in which DCs of the master storage and the backup storage operate. FIG. 3B is a diagram illustrating a case in which DCs of the backup storage and the reserve storage operate. FIG. 3C is a diagram illustrating a case in which DCs of the master storage and the reserve storage operate. The VM (A) illustrated in each diagram is assumed to be a VM mainly used by the DC 1 in A country which plays a role of the master storage. Specifically, for the VM (A), the DC 1 in A country is the master storage, the DC 2 in B country is the backup storage, and the DC 3 in C country is the reserve storage. The management server 16 of the DC 1 in A country is the “lead”.

As illustrated in FIG. 3A, the A country and the B country are in daylight hours, so that the VM operation facilities 15 and 25 of the DC 1 in A country and the DC 2 in B country operate. The C country is in night hours, so that a VM operation facility 35 of the DC 3 in C country stops. In the DC 1 in A country, the VM (A) executes I/O (Input/Output) processing and data is written to the virtual disk of the master storage volume 101 of the storage device 153. Then, the management unit 161 remotely copies written update data as the backup data to the virtual disk of the backup storage volume 202 of the DC 2 in B country. Thereby, redundant is made to the data for the VM (A) in the master storage volume 101 and the backup storage volume 202. In summary, the DC 1 in A country that plays a role of the master storage operates the VM (A) and the DC 2 in B country that plays a role of the backup storage stores the updated data as the backup data.

As illustrated in FIG. 3B, the A country is in night hours, so that the VM operation facility 15 of the DC 1 in A country stops. The B country and the C country are in daylight hours, so that the VM operation facilities 25 and 35 of the DC 2 in B country and the DC 3 in C country operate. The management unit 161 transfers the operation of the VM (A) from the DC 1 in A country to the DC 2 in B country. When the operation is transferred, the virtual disk for the VM (A) in the backup storage volume 202 is equivalent to the virtual disk in the master storage volume 101. In the DC 2 in B country, the VM (A) executes I/O processing and data is written to the backup storage volume 202 (here, backup 2) of a storage device 253. In other words, the written update data is stored as the difference data into the backup 2 that is an area different from backup 1 in the backup storage volume 202. Then, the management unit 161 remotely copies the stored difference data to the reserve storage volume 303 of the DC 3 in C country through a management unit 261. Thereby, for the VM (A), redundant is made to the difference data in the backup storage volume 202 and the difference data in the reserve storage volume 303. In summary, the DC 2 in B country that plays a role of the backup storage operates the VM and the DC 3 in C country that plays a role of the reserve storage stores the updated data as the reserve data.

As illustrated in FIG. 3C, the A country and the C country are in daylight hours, so that the VM operation facilities 15 and 35 of the DC 1 in A country and the DC 3 in C country operate. The B country is in night hours, so that the VM operation facility 25 of the DC 2 in B country stops. The management unit 161 transfers the operation of the VM (A) from the DC 2 in B country to the DC 1 in A country. When the operation is transferred, the virtual disk for the VM (A) in the backup storage volume 202 is equivalent to the virtual disk in the master storage volume 101. In the DC 1 in A country, the VM (A) executes I/O processing and data is written to the master storage volume 101 (here, master 2) of the storage device 153. In other words, the written update data is stored as the difference data into the master 2 that is an area different from master 1 in the master storage volume 101. Then, the management unit 161 remotely copies the written update data to the reserve storage volume 303 of the DC 3 in C country through a management unit 361. Thereby, for the VM (A), redundant is made to the difference data in the master storage volume 101 and the difference data in the reserve storage volume 303. In summary, the DC 1 in A country that plays a role of the master storage operates the VM and the DC 3 in C country that plays a role of the reserve storage stores the updated data as the reserve data.

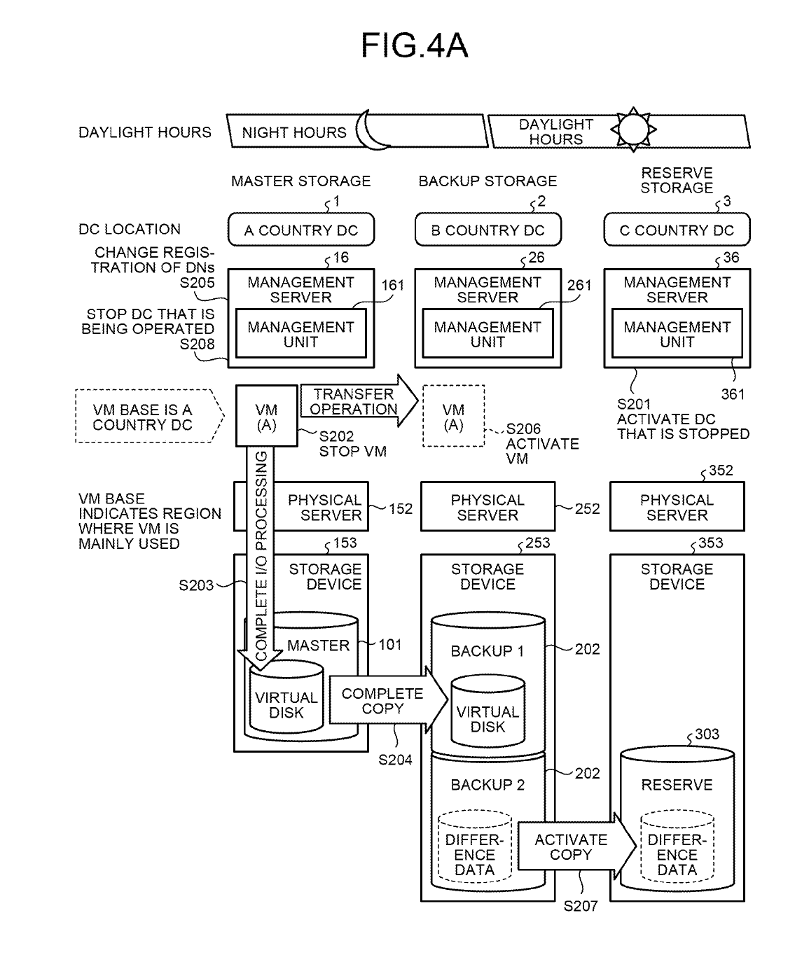

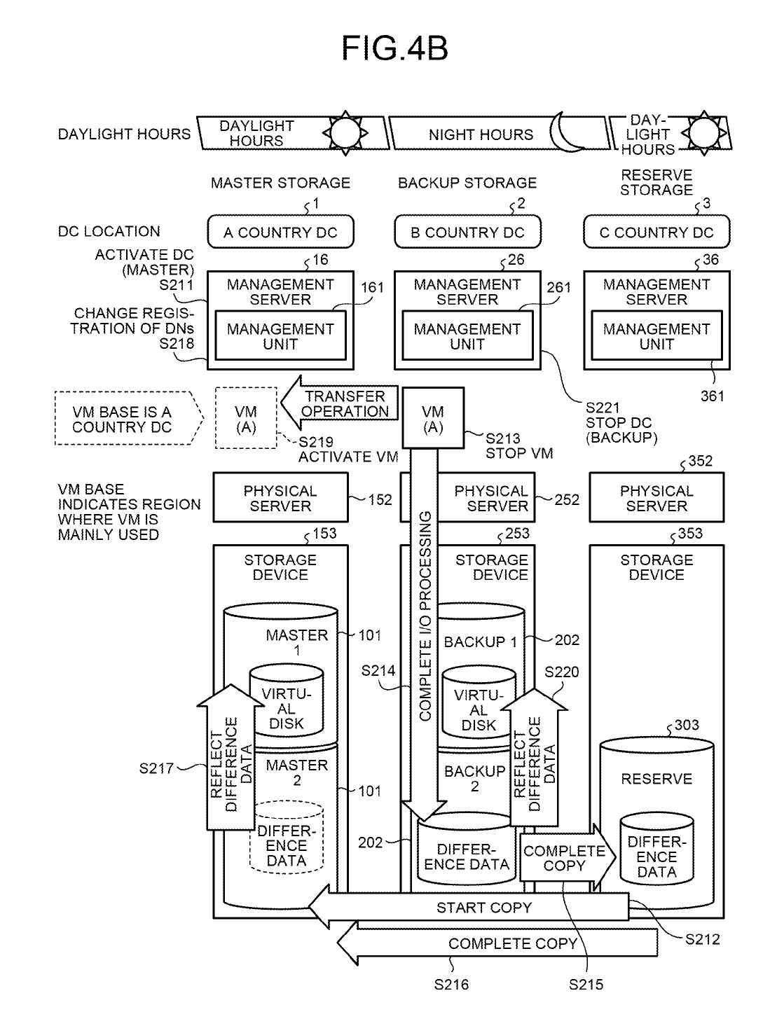

An overview of a process of transferring VM between the DCs for the VM (A) will be described with reference to FIGS. 4A and 4B. FIG. 4A is a diagram illustrating a case in which the VM is transferred from the master storage to the backup storage. FIG. 4B is a diagram illustrating a case in which the VM is transferred from the backup storage to the master storage. For the VM (A), the DC 1 in A country is the master storage, the DC 2 in B country is the backup storage, and the DC 3 in C country is the reserve storage. The management server 16 of the DC 1 in A country is the “lead”.

FIG. 4A is a case in which the B country and the C country are in daylight hours and the A country is in night hours. As illustrated in FIG. 4A, the DC 1 in A country is in night hours, so that the DC 1 starts transferring the operation of the VM (A). The management unit 161 activates the VM operation facility 35 of the DC 3 in C country, which is stopped, through the management unit 361 (S201). Then, the management unit 161 stops the VM (A) that is being operated (S202). Then, the VM (A) completes I/O processing being executed (S203) and copies update data in process to the virtual disk in the backup storage volume 202 of the DC 2 in B country (S204). Then, the management unit 161 changes registration of Domain Name System (DNS) to change setting of network (S205).

Subsequently, the management unit 161 notifies the DC 2 in B country to activate the VM (A) to transfer the VM (A) between the DCs (S206). Then, in the DC 2 in B country, the VM (A) starts I/O processing and writes data to the backup storage volume 202 (here, backup 2) of the storage device 253. Then, the VM (A) stores the written update data in the backup 2 of the backup storage volume 202 as the difference data of data on the virtual disk. Then, the management unit 261 starts (activates) remote copy of the stored difference data to the reserve storage volume 303 of the DC 3 in C country (S207). Thereby, the operation of the VM (A) is started in the DC 2 in B country which plays a role of the backup storage.

Thereafter, when the operation of the VM (A) is started in the DC 2 in B country, the management unit 161 stops the VM operation facility 15 of the DC 1 in A country, which is being operated, (S208). As a result, when the operation is transferred, the management unit 161 can shorten the period of time to transfer the VM (A) by copying only the update data in process to the virtual disk of the backup storage.

FIG. 4B is a case in which the A country and the C country are in daylight hours and the B country is in night hours. As illustrated in FIG. 4B, the DC 1 in A country is in daylight hours, so that the DC 1 starts transferring the operation of the VM (A) from the DC 2 in B country. The management unit 161 activates the VM operation facility 15 of the DC 1 in A country (S211). Then, the management unit 161 instructs activation of copy from the reserve storage to the master storage and the management unit 361 starts (activates) remote copy of the difference data stored as the reserve data to the master storage volume 101 (here, master 2) of the DC 1 in A country (S212). Then, the management unit 161 stops the VM (A) that is being operated in the DC 2 in B country (S213). Then, in the DC 2 in B country, the VM (A) completes I/O processing being executed (S214) and writes update data in process to the backup storage volume 202 (here, backup 2) of the storage device 253. In other words, the written update data is stored as the difference data into the backup 2 that is an area different from the backup 1 in the backup storage volume 202.

Subsequently, the management unit 261 remotely copies the stored difference data to the reserve storage volume 303 in a storage device 353 of the DC 3 in C country through the management unit 361 (S215). Then, the management unit 361 remotely copies the difference data to the master storage volume 101 (here, master 2) of the DC 1 in A country and completes the copy (S216). Thereby, the difference data in the backup storage and the difference data in the master storage become equivalent.

Subsequently, the management unit 161 reflects the difference data in the master 2 to the virtual disk in the master storage volume 101 (here, master 1) (S217). Then, the management unit 161 changes registration of DNS to change setting of network (S218).

Subsequently, the management unit 161 causes the DC 1 in A country to activate the VM (A) to transfer the VM (A) between the DCs (S219). Then, in the DC 1 in A country, the VM (A) starts I/O processing and writes data to the master storage volume 101 (here, master 2) of the storage device 153. Then, the VM (A) stores the written update data as the difference data of data on the virtual disk. Then, the management unit 161 starts (activates) remote copy of the stored difference data to the reserve storage volume 303 of the DC 3 in C country. Thereby, the operation of the VM (A) is started in the DC 1 in A country which plays a role of the master storage.

Further, the management unit 161 reflects the difference data in the backup 2 to the virtual disk of the backup 1 of the DC 2 in B country through the management unit 261 (S220). Then, the management unit 161 stops the VM operation facility 25 of the DC 2 in B country, which is being operated, through the management unit 261 (S221). Thereby, when the operation is transferred, the management unit 161 can shorten the period of time to transfer the VM (A) by copying only the difference data in the reserve storage to the difference data in the master storage.

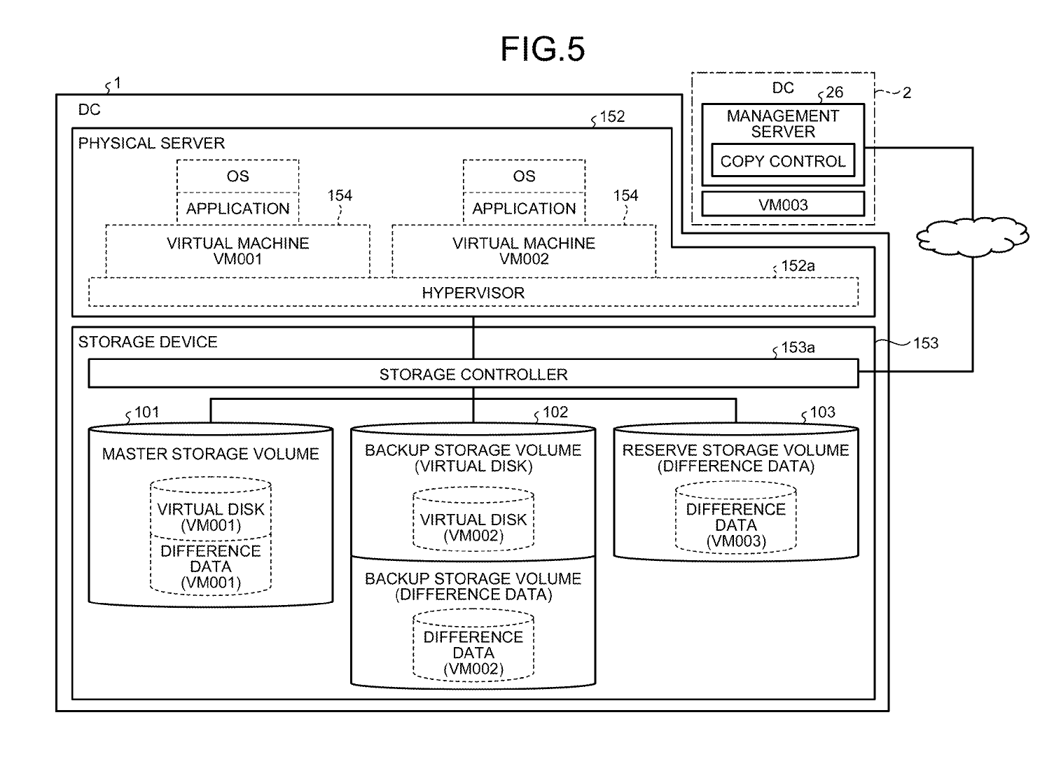

Next, the relationship between the virtual machine (VM) in the DC 1 and the storage destination volume of data processed by the VM will be described with reference to FIG. 5. FIG. 5 is a diagram illustrating the relationship between the virtual machine and the storage destination volume. In the description of FIG. 5, it is assumed that there are VM001, VM002, and VM003 as the virtual machines 154. Regarding a role of each VM in the DC 1 as a storage, the VM001 plays a role of the master storage, the VM002 plays a role of the backup storage, and the VM003 plays a role of the reserve storage.

As illustrated in FIG. 5, the VM001 and VM002 are being operated. The VM001 uses the DC 1 as a role of the master storage, so that when executing I/O processing, the VM001 writes processed data to the master storage volume 101 of the storage device 153. The VM002 uses the DC 1 as a role of the backup storage, so that when executing I/O processing, the VM002 writes processed data to the backup storage volume 102 of the storage device 153. The VM003 uses the DC 1 as a role of the reserve storage, so that data processed in another DC 2 for the VM003 is written to the reserve storage volume 103 as the difference data.

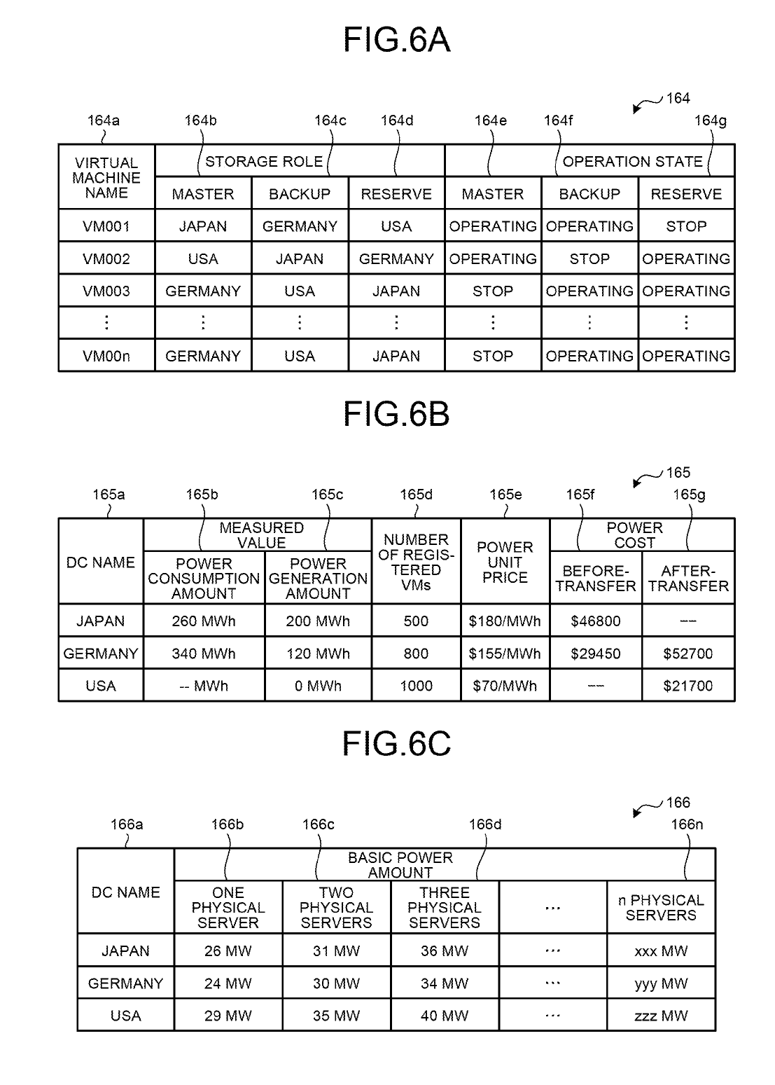

Next, a data structure of the storage status table 164 will be described with reference to FIG. 6A. FIG. 6A is a diagram illustrating an example of the data structure of the storage status table. As illustrated in FIG. 6A, the storage status table 164 stores DC bases whose storage role is a master 164b, a backup 164c, and a reserve 164d, respectively, in association with a virtual machine name 164a. Further, the storage status table 164 stores operation states of DCs whose storage role is a master 164e, a backup 164f, and a reserve 164g, respectively, in association with the virtual machine name 164a.

As an example, when the virtual machine name 164a is “VM001”, the storage status table 164 stores the DC base whose storage role is the master 164b is “Japan”, the DC base whose storage role is the backup 164c is “Germany”, and the DC base whose storage role is the reserve 164d is “USA”. Further, the storage status table 164 stores the operation state of the DC whose storage role is the master 164e is “operating”, the operation state of the DC whose storage role is the backup 164f is “operating”, and the operation state of the DC whose storage role is the reserve 164g is “stop”.

Next, a data structure of the DC power status table 165 will be described with reference to FIG. 6B. FIG. 6B is a diagram illustrating an example of the data structure of the DC power status table. As illustrated in FIG. 6B, the DC power status table 165 stores a power consumption amount 165b and a power generation amount 165c which indicate measured values, a number of registered VMs 165d, a power unit price 165e, and a before-transfer 165f and an after-transfer 165g which indicate the power cost, in association with a DC name 165a. The DC name 165a indicates the name of the DC. The power consumption amount 165b indicates the amount of power consumed by the DC indicated by the DC name 165a. The power generation amount 165c indicates the amount of power generated by the DC indicated by the DC name 165a. The number of registered VMs 165d indicates the number of VMs operated by the DC indicated by the DC name 165a. The power unit price 165e indicates the unit price in a case in which the power is consumed by the DC indicated by the DC name 165a. The before-transfer 165f indicates the power cost before transfer. The after-transfer 165g indicates the power cost after transfer.

As an example, when the DC name 165a is “Japan”, the DC power status table 165 stores “260 MWh (megawatt-hour)” as the power consumption amount 165b, “200 MWh” as the power generation amount 165c, “500” as the number of registered VMs 165d, and “$180/MWh” as the power unit price 165e. The DC power status table 165 stores “$46800” as the power cost before-transfer 165f and “--” as the power cost after-transfer 165g.

Next, a data structure of the DC basic power amount table 166 will be described with reference to FIG. 6C. FIG. 6C is a diagram illustrating an example of the data structure of the DC basic power amount table. As illustrated in FIG. 6C, the DC basic power amount table 166 stores the basic power amount according the number of operating physical servers in association with a DC name 166a. As an example, when the DC name 166a is “Japan”, the DC basic power amount table 166 stores “26 MW (megawatt)” as one physical server 166b, “31 MW” as two physical servers 166c, “36 MW” as three physical servers 166d, “xxx MW” as n physical servers 166n.

Sequence of DC Management Process

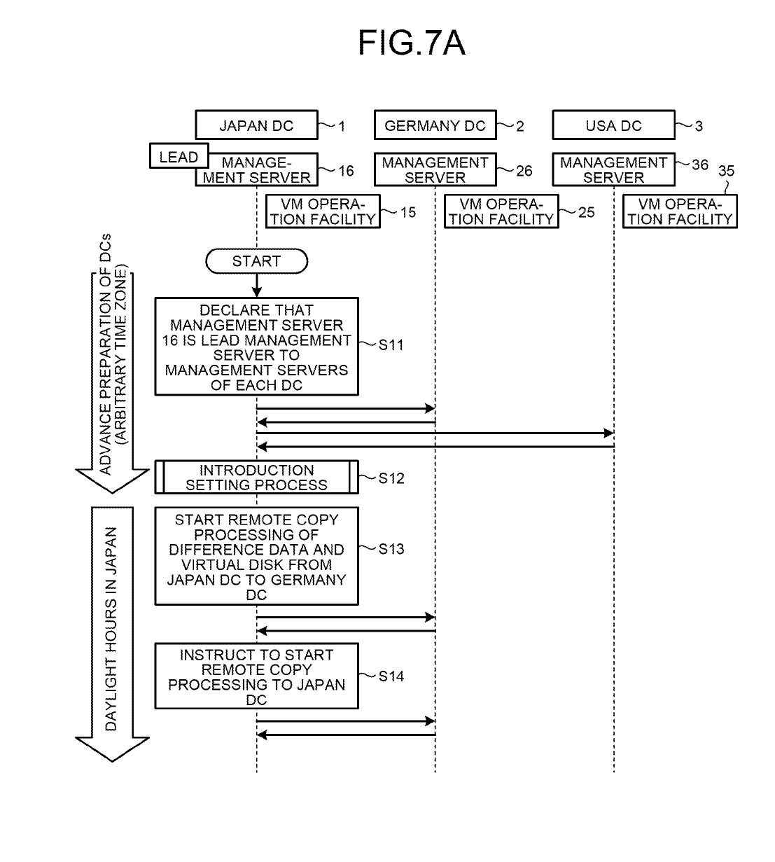

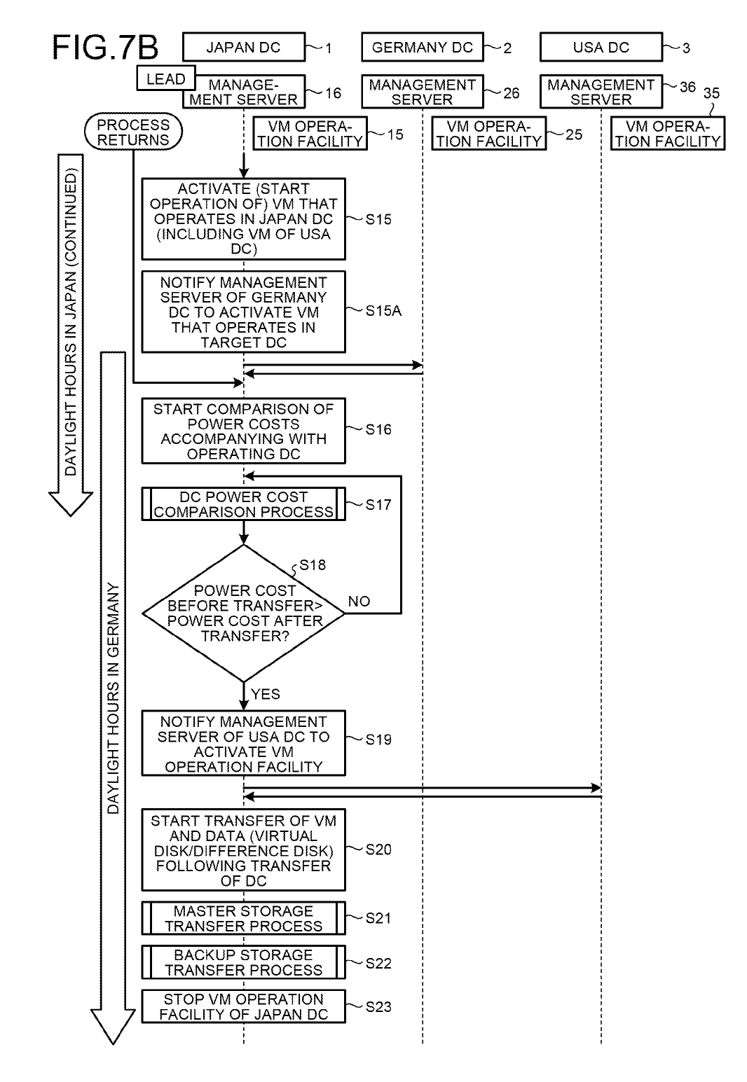

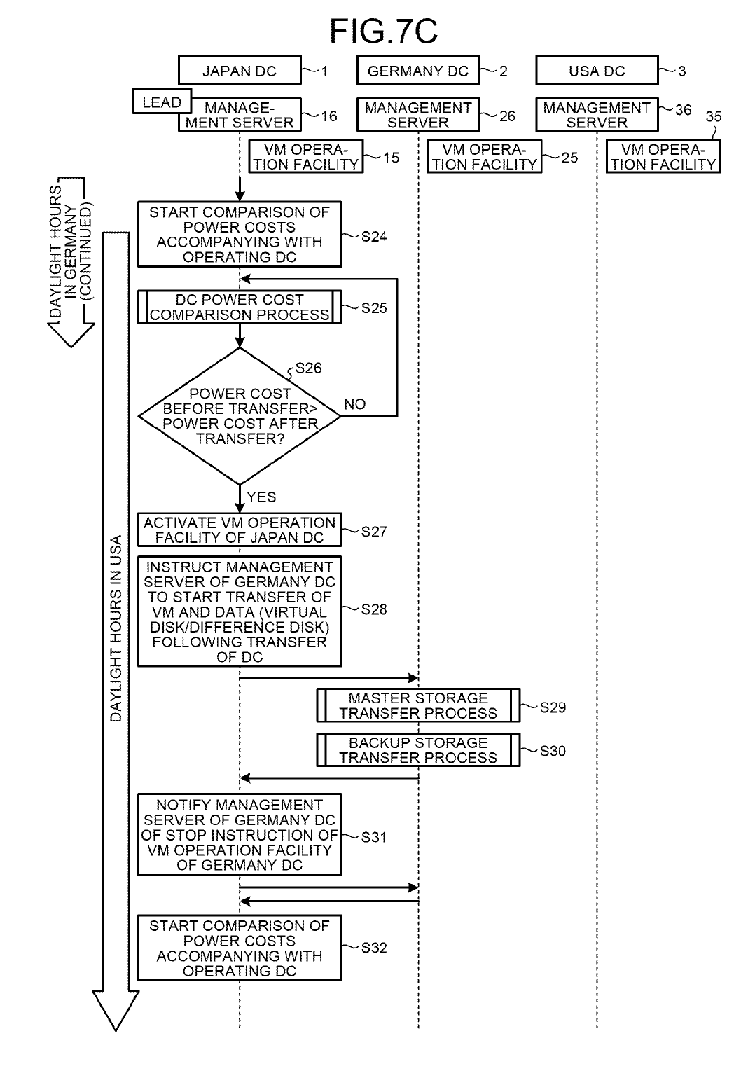

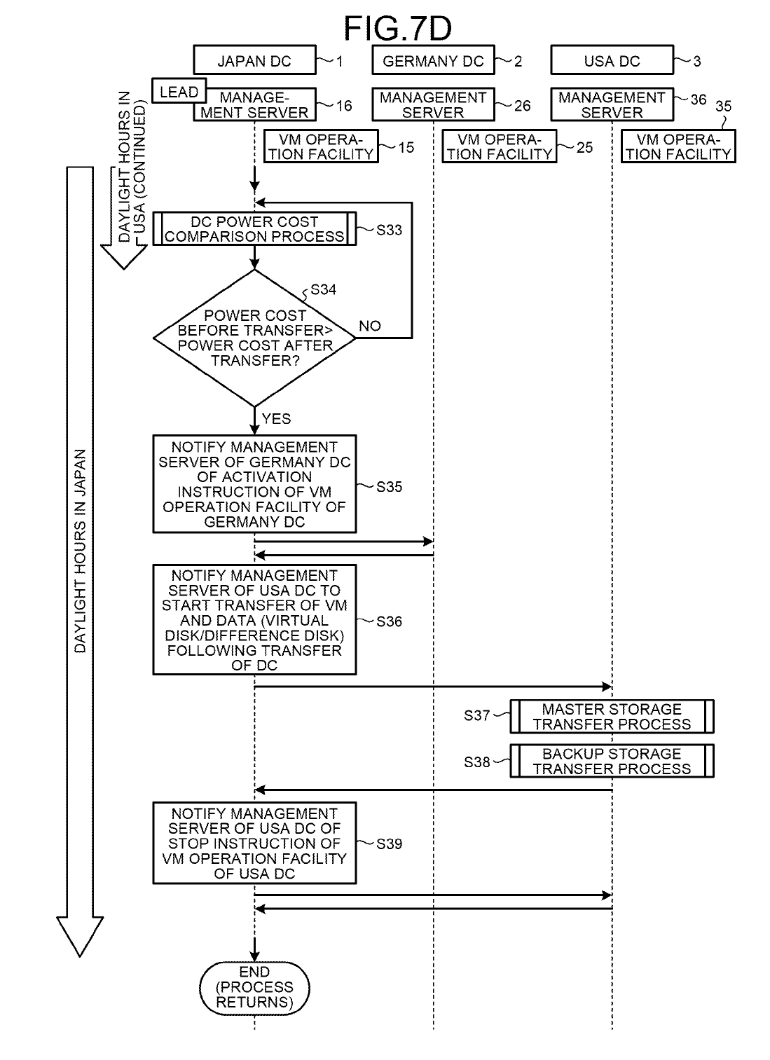

Next, the sequence of DC management process performed by the management unit 161 when the management server 16 is the “lead” will be described with reference to FIGS. 7A to 7D. FIGS. 7A to 7D are diagrams illustrating the sequence of the DC management process according to the embodiment. In the description of FIGS. 7A to 7D, it is assumed that the Japan DC is DC 1, the Germany DC is DC 2, and the USA DC is DC 3.

In the management server 16 of the Japan DC 1, the management unit 161 declares that the management server 16 is the lead management server to the management server 26 of the Germany DC 2 and the management server 36 of the USA DC 3 (step S11). Then, the management unit 161 executes an introduction setting process (step S12). In the introduction setting process, for the virtual machine “VM001”, the Japan DC 1 is set to play the role of the master storage, the Germany DC 2 is set to play the role of the backup storage, and the USA DC 3 is set to play the role of the reserve storage. For the virtual machine “VM002”, the USA DC 3 is set to play the role of the master storage, the Japan DC 1 is set to play the role of the backup storage, and the Germany DC 2 is set to play the role of the reserve storage. For the virtual machine “VM003”, the Germany DC 2 is set to play the role of the master storage, the USA DC 3 is set to play the role of the backup storage, and the Japan DC 1 is set to play the role of the reserve storage. The details of the introduction setting process will be described later.

Here, it is assumed that Japan and Germany are in daylight hours and USA is in night hours. Then, the management unit 161 starts remote copy processing of the update data and the difference data written to the virtual disk from the Japan DC 1 to the Germany DC 2 (step S13). For example, when “VM001” executes I/O processing, data is written to the virtual disk of the master storage volume 101 in the storage device 153. Then, the management unit 161 remotely copies the written update data to the virtual disk of the backup storage volume 202 of the Germany DC 2 through the management unit 261. When “VM002” executes I/O processing, data is written as the difference data to the backup storage volume 102 in the storage device 153. Then, the management unit 161 remotely copies the written difference data to a reserve storage volume 203 of the Germany DC 2 through the management unit 261.

Then, the management unit 161 instructs the management server 26 of the Germany DC 2 to start the remote copy processing from the Germany DC 2 to the Japan DC 1 (step S14). For example, when “VM003” executes I/O processing in the Germany DC 2, data is written to the virtual disk of a master storage volume 201 in the storage device 253. Then, the management unit 261 of the management server 26 remotely copies the written update data to the virtual disk of the backup storage volume 102 of the Japan DC 1.

Then, the management unit 161 activates (starts operation of) the VM that operates in the Japan DC 1 (including the VM of the USA DC 3) (step S15). Here, the VM that operates in the Japan DC 1 is “VM001” and “VM002”. Then, the management unit 161 notifies the management server 26 of the Germany DC 2 to activate the VM that operates in the Germany DC 2 (step S15A).

Here, it is assumed that Japan gradually becomes night hours and Germany and USA are in daylight hours. The management unit 161 starts comparison of the power costs accompanying with operating DC (step S16) and executes a DC power cost comparison process (step S17). The details of the DC power cost comparison process will be described later.

Then, the management unit 161 determines whether or not the power cost of the DC from which the VM has not yet been transferred and in which the VM is being operated is higher than the power cost of the DC to which the VM has been transferred in a case in which the VM has been transferred (step S18). When the management unit 161 determines that the power cost of the DC from which the VM has not yet been transferred and in which the VM is being operated is not higher than the power cost of the DC to which the VM has been transferred in a case in which the VM has been transferred (step S18: No), the management unit 161 proceeds to step S17 to repeat the determination process.

On the other hand, when the management unit 161 determines that the power cost of the DC from which the VM has not yet been transferred and in which the VM is being operated is higher than the power cost of the DC to which the VM has been transferred in a case in which the VM has been transferred (step S18: Yes), the management unit 161 starts a transfer process to the DC to which the VM has been transferred in a case in which the VM has been transferred. Specifically, the management unit 161 notifies the management server 36 of the USA DC 3 to activate the VM operation facility 35 (step S19) and starts transfer of the VM and the like (step S20).

Then, the management unit 161 executes a master storage transfer process (step S21). Specifically, the management unit 161 executes the transfer process of the VM in which the storage role of the Japan DC 1 whose VM operation facility 15 is to be stopped is the master. Then, the management unit 161 executes a backup storage transfer process (step S22). Specifically, the management unit 161 executes the transfer process of the VM in which the storage role of the Japan DC 1 whose VM operation facility 15 is to be stopped is the backup. The details of the master storage transfer process and the backup storage transfer process will be described later. Then, the management unit 161 stops the VM operation facility 15 of the Japan DC 1 (step S23).

Here, it is assumed that Germany gradually becomes night hours and USA and Japan are in daylight hours. The management unit 161 starts comparison of the power costs accompanying with operating DC (step S24) and executes the DC power cost comparison process (step S25).

Then, the management unit 161 determines whether or not the power cost of the DC from which the VM has not yet been transferred and in which the VM is being operated is higher than the power cost of the DC to which the VM has been transferred in a case in which the VM has been transferred (step S26). When the management unit 161 determines that the power cost of the DC from which the VM has not yet been transferred and in which the VM is being operated is not higher than the power cost of the DC to which the VM has been transferred in a case in which the VM has been transferred (step S26: No), the management unit 161 proceeds to step S25 to repeat the determination process.

On the other hand, when the management unit 161 determines that the power cost of the DC from which the VM has not yet been transferred and in which the VM is being operated is higher than the power cost of the DC to which the VM has been transferred in a case in which the VM has been transferred (step S26: Yes), the management unit 161 starts a transfer process to the DC to which the VM has been transferred in a case in which the VM has been transferred. Specifically, the management unit 161 notifies activation of the VM operation facility 15 of the Japan DC 1 (step S27) and notifies start of the transfer (step S28).

Then, the management unit 161 executes the master storage transfer process to the Germany DC 2 (step S29). Specifically, the management unit 161 executes the transfer process of the VM in which the storage role of the Germany DC 2 whose VM operation facility 25 is to be stopped is the master. Then, the management unit 161 executes the backup storage transfer process (step S30). Specifically, the management unit 161 executes the transfer process of the VM in which the storage role of the Germany DC 2 whose VM operation facility 25 is to be stopped is the backup. Then, the management unit 161 notifies the management server 26 of the Germany DC 2 of stop instruction of the VM operation facility 25 of the Germany DC 2 (step S31).

Here, it is assumed that USA gradually becomes night hours and Japan and Germany are in daylight hours. The management unit 161 starts comparison of the power costs accompanying with operating DC (step S32) and executes the DC power cost comparison process (step S33).

Then, the management unit 161 determines whether or not the power cost of the DC from which the VM has not yet been transferred and in which the VM is being operated is higher than the power cost of the DC to which the VM has been transferred in a case in which the VM has been transferred (step S34). When the management unit 161 determines that the power cost of the DC from which the VM has not yet been transferred and in which the VM is being operated is not higher than the power cost of the DC to which the VM has been transferred in a case in which the VM has been transferred (step S34: No), the management unit 161 proceeds to step S33 to repeat the determination process.

On the other hand, when the management unit 161 determines that the power cost of the DC from which the VM has not yet been transferred and in which the VM is being operated is higher than the power cost of the DC to which the VM has been transferred in a case in which the VM has been transferred (step S34: Yes), the management unit 161 starts a transfer process to the DC to which the VM has been transferred in a case in which the VM has been transferred. Then, the management unit 161 notifies the management server 26 of the Germany DC 2 of activation instruction of the VM operation facility 25 of the Germany DC 2 (step S35) and notifies start of the transfer (step S36).

Then, the management unit 161 executes the master storage transfer process to the USA DC 3 (step S37). Specifically, the management unit 161 executes the transfer process of the VM in which the storage role of the USA DC 3 whose VM operation facility 35 is to be stopped is the master. Then, the management unit 161 executes the backup storage transfer process (step S38). Specifically, the management unit 161 executes the transfer process of the VM in which the storage role of the USA DC 3 whose VM operation facility 35 is to be stopped is the backup. Then, the management unit 161 notifies the management server 36 of the USA DC 3 of stop instruction of the VM operation facility 35 of the USA DC 3 (step S39). In this way, when each DC base becomes night hours, the management unit 161 executes a DC transfer process.

Sequence of Introduction Setting Process

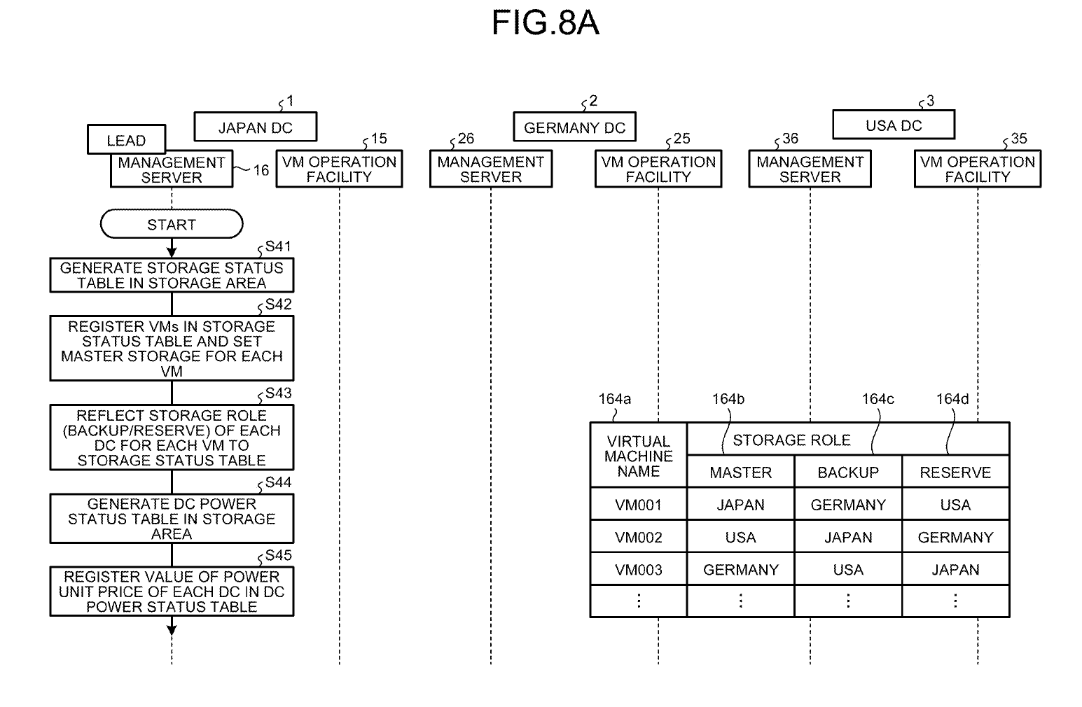

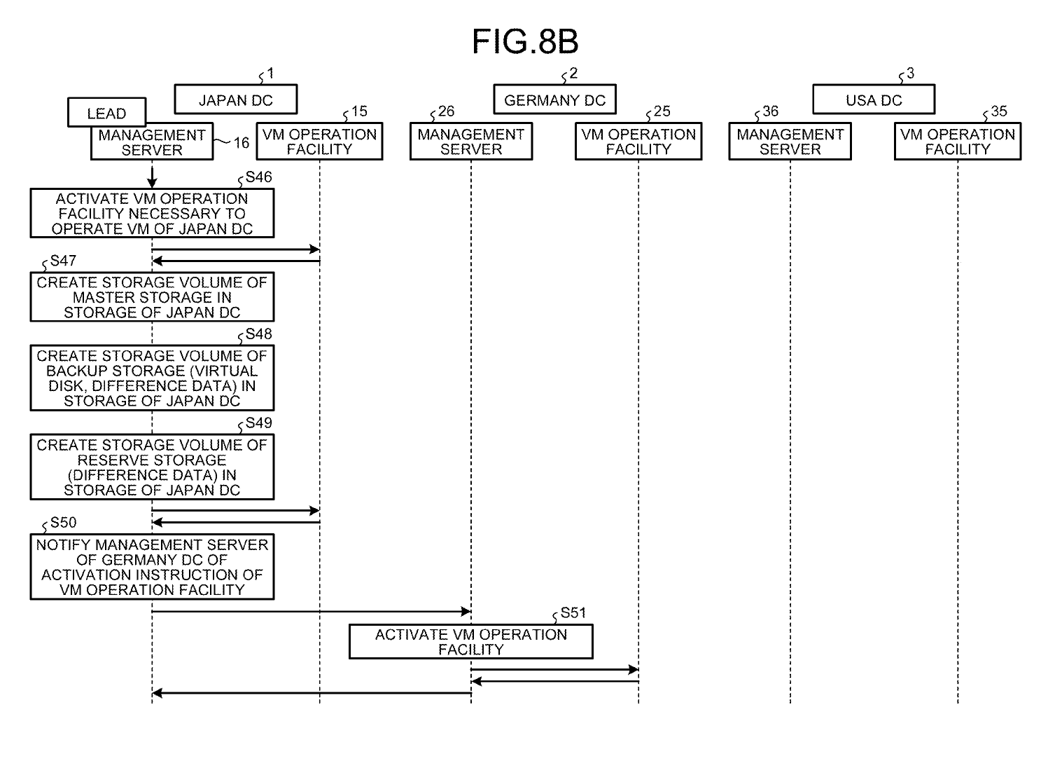

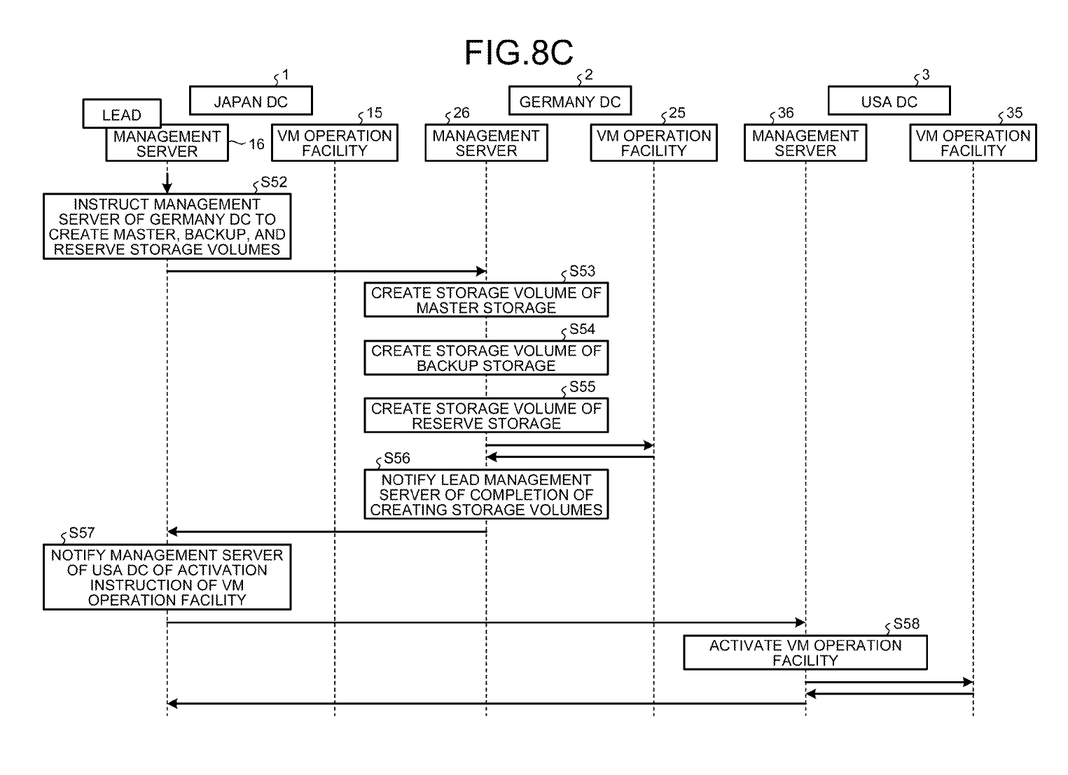

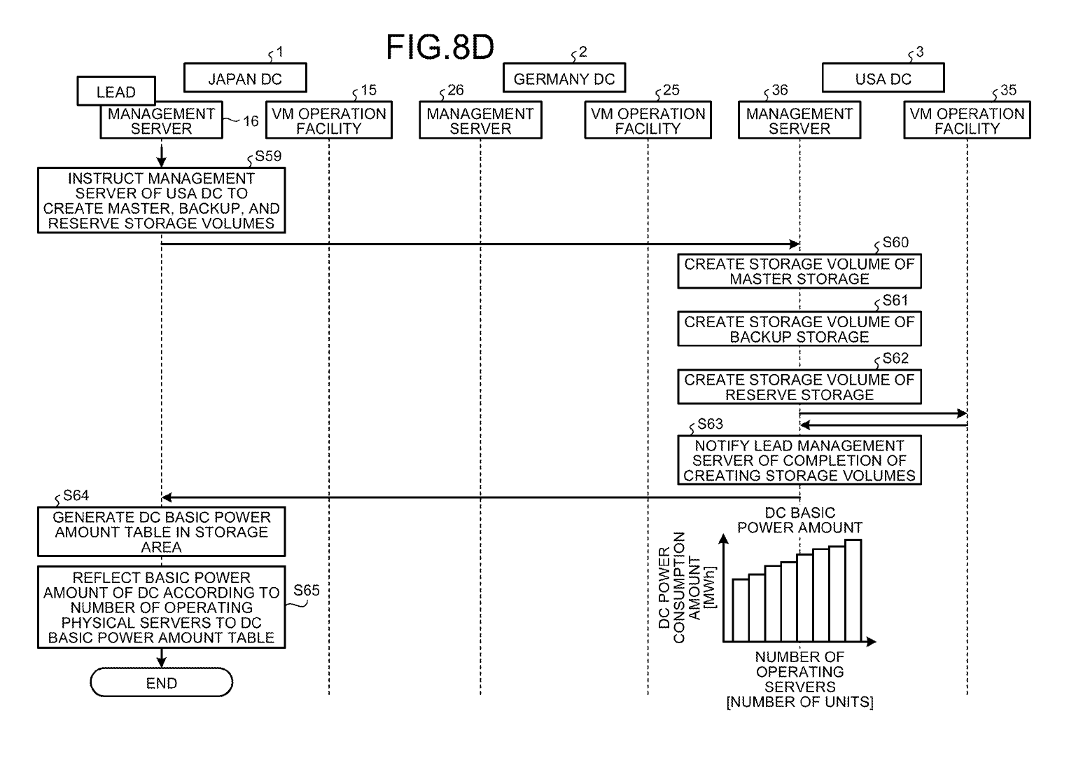

Next, a sequence of the introduction setting process performed by the management unit 161 will be described with reference to FIGS. 8A to 8D. FIGS. 8A to 8D are diagrams illustrating the sequence of the introduction setting process. In the description of FIGS. 8A to 8D, it is assumed that the Japan DC is DC 1, the Germany DC is DC 2, and the USA DC is DC 3. In FIGS. 8A to 8D, the management server 16 of the Japan DC 1 is the lead.

The management unit 161 generates the storage status table 164 in a storage area (step S41). Then, the management unit 161 registers names of VMs inputted by, for example, a system administrator in the virtual machine name 164a of the storage status table 164. Then, the management unit 161 sets a master storage for each VM (step S42). In other words, the management unit 161 sets a DC whose storage role is the master storage for each VM. The DC whose storage role is the master storage is a base which mainly uses the VM.

Then, the management unit 161 reflects the storage role (backup/reserve) of each DC for each VM to the storage status table 164 (step S43). For example, it is assumed that “VM001”, “VM002”, and “VM003” are registered in the virtual machine name 164a. The management unit 161 sets a DC base whose storage role is the master 164b to “Japan” for “VM001”. Then, the management unit 161 sets a DC base whose storage role is the backup 164c to “Germany” and sets a DC base whose storage role is the reserve 164d to “USA” according to the temporal order of the daylight hours. In the same manner, the management unit 161 sets a DC base whose storage role is the master 164b to “USA” for “VM002”. Then, the management unit 161 sets a DC base whose storage role is the backup 164c to “Japan” and sets a DC base whose storage role is the reserve 164d to “Germany” according to the temporal order of the daylight hours.

Subsequently, the management unit 161 generates the DC power status table 165 in a storage area (step S44). Then, the management unit 161 registers the value of power unit price of each DC inputted by, for example, a system administrator in the power unit price 165e of the DC power status table 165 (step S45).

Subsequently, the management unit 161 starts the VM operation facility 15 that is used to operate the VM of the Japan DC 1 (step S46). The VM operation facility 15 includes, for example, a power supply facility, an air conditioning facility, and a physical server. Then, the management unit 161 creates a storage volume (the master storage volume 101) of the master storage in the storage device 153 of the Japan DC 1 (step S47). The management unit 161 creates a storage volume (the backup storage volume 102) of the backup storage (virtual disk, difference data) in the storage device 153 of the Japan DC 1 (step S48). The management unit 161 creates a storage volume (the reserve storage volume 103) of the reserve storage (difference data) in the storage device 153 of the Japan DC 1 (step S49).

Subsequently, the management unit 161 notifies the management server 26 of the Germany DC 2 of activation instruction of the VM operation facility 25 that is used to operate the VM of the Germany DC 2 (step S50). Then, in the management server 26 of the Germany DC 2, the management unit 261 activates the VM operation facility 25 (step S51).

Then, when the completion of activation the VM operation facility 25 is notified from the management unit 261, the management unit 161 instructs the management server 26 of the Germany DC 2 to create the master, backup, and reserve storage volumes (step S52). Then, in the management server 26, the management unit 261 creates a storage volume (the master storage volume 201) of the master storage in the storage device 253 of the Germany DC 2 (step S53). The management unit 261 creates a storage volume (the backup storage volume 202) of the backup storage (virtual disk, difference data) in the storage device 253 of the Germany DC 2 (step S54). The management unit 261 creates a storage volume (the reserve storage volume 203) of the reserve storage (difference data) in the storage device 253 of the Germany DC 2 (step S55). Then, the management unit 261 notifies the lead management server 16 of the completion of creating the storage volumes (step S56).

Subsequently, the management unit 161 notifies the management server 36 of the USA DC 3 of activation instruction of the VM operation facility 35 that is used to operate the VM of the USA DC 3 (step S57). Then, in the management server 36 of the USA DC 3, the management unit 361 activates the VM operation facility 35 (step S58).

Then, when the completion of activation the VM operation facility 35 is notified from the management unit 361, the management unit 161 instructs the management server 36 of the USA DC 3 to create the master, backup, and reserve storage volumes (step S59). Then, in the management server 36, the management unit 361 creates a storage volume (a master storage volume 301) of the master storage in the storage device 353 of the USA DC 3 (step S60). The management unit 361 creates a storage volume (a backup storage volume 302) of the backup storage (virtual disk, difference data) in the storage device 353 of the USA DC 3 (step S61). The management unit 361 creates a storage volume (the reserve storage volume 303) of the reserve storage (difference data) in the storage device 353 of the USA DC 3 (step S62). Then, the management unit 361 notifies the lead management server 16 of the completion of creating the storage volumes (step S63).

Then, the management unit 161 generates the DC basic power amount table 166 in a storage area (step S64). Then, the management unit 161 reflects the basic power amount of each DC according to the number of operating physical servers to the DC basic power amount table 166 (step S65). For example, the management unit 161 sets the basic power amount of each DC inputted by a system administrator in the DC basic power amount table 166. Then, the management unit 161 terminates the introduction setting process.

Sequence of DC Power Cost Comparison Process

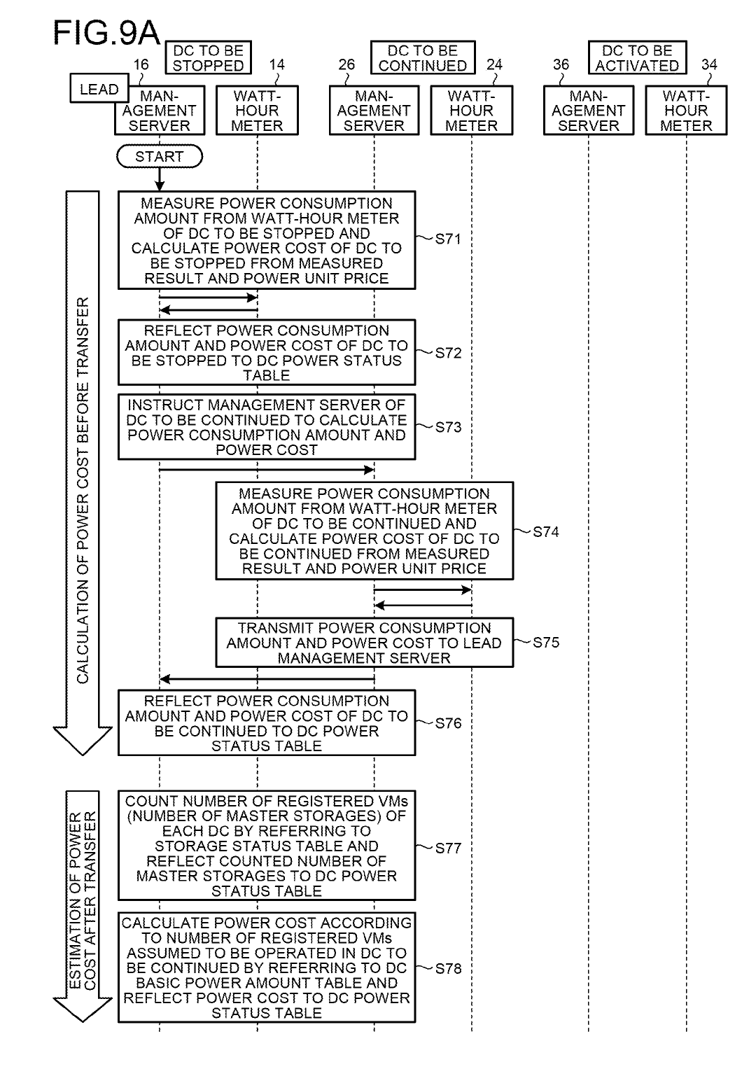

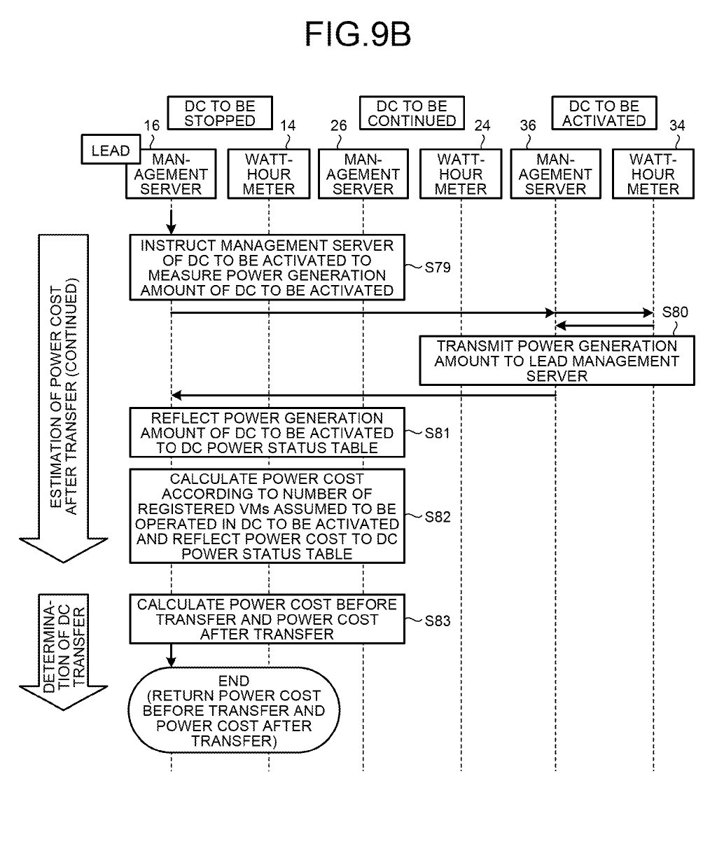

Next, a sequence of the DC power cost comparison process performed by the management unit 161 will be described with reference to FIGS. 9A and 9B. FIGS. 9A and 9B are diagrams illustrating the sequence of the DC power cost comparison process. In the description of FIGS. 9A and 9B, it is assumed that the Japan DC is a DC to be stopped, the Germany DC is a DC to be continued, and the USA DC is a DC to be activated. The DC to be stopped means a DC which is currently operating but whose operation is stopped due to sunset. The DC to be continued means a DC which is currently operating and whose operation is continued. The DC to be activated means a DC which is currently stopped but whose operation is started due to sunrise. In FIGS. 9A and 9B, the management server 16 of the Japan DC is the lead.

The management unit 161 measures the power consumption amount from the watt-hour meter 14 of the DC to be stopped and calculates the power cost of the DC to be stopped from the measured result and the power unit price (step S71). Then, the management unit 161 reflects the power consumption amount 165b and the power cost (before-transfer 165f) of the DC to be stopped to the DC power status table 165 (step S72).

Subsequently, the management unit 161 instructs the management server 26 of the DC to be continued to calculate the power consumption amount and the power cost (step S73). In the management server 26 of the DC to be continued, the management unit 261 measures the power consumption amount from a watt-hour meter 24 of the DC to be continued and calculates the power cost of the DC to be continued from the measured result and the power unit price (step S74). Then, the management unit 261 transmits the power consumption amount and the power cost to the lead management server 16 (step S75).

Then, the management unit 161 of the management server 16 reflects the power consumption amount 165b and the power cost (before-transfer 165f) of the DC to be continued to the DC power status table 165 (step S76).

Then, the management unit 161 of the management server 16 counts the number of registered VMs (the number of master storages) of each DC by referring to the storage status table 164. Then, the management unit 161 reflects the counted number of master storages to the number of registered VMs 165d in the DC power status table 165 (step S77).

Then, the management unit 161 calculates the power cost according to the number of registered VMs assumed to be operated in the DC to be continued by referring to the DC power status table 165 and the DC basic power amount table 166. Then, the management unit 161 reflects the power cost to the power cost (after-transfer 165g) in the DC power status table 165 (step S78). For example, the management unit 161 calculates the power cost after transfer of the DC to be continued based on the following Formula (1):

Power cost ($)={basic power amount according to the number of registered VMs of DC to be continued (master+backup)−power generation amount of DC to be continued}×power unit price of DC to be continued Formula (1)

Subsequently, the management unit 161 instructs the management server 36 of the DC to be activated to measure the power generation amount of the DC to be activated (step S79). In the management server 36 of the DC to be activated, the management unit 361 transmits the measured power generation amount to the lead management server 16 (step S80). Then, the management unit 161 of the management server 16 reflects the power generation amount of the DC to be activated to the power generation amount 165c in the DC power status table 165 (step S81).

Then, the management unit 161 calculates the power cost according to the number of registered VMs assumed to be operated in the DC to be activated by referring to the DC power status table 165 and the DC basic power amount table 166. Then, the management unit 161 reflects the power cost to the power cost (after-transfer 165g) in the DC power status table 165 (step S82). For example, the management unit 161 calculates the power cost after transfer of the DC to be activated on the basis of the following Formula (2):

Power cost ($)={basic power amount according to the number of registered VMs of DC to be activated (master+backup)−power generation amount of DC to be activated}×power unit price of DC to be activated Formula (2)

Then, the management unit 161 calculates the power cost before transfer and the power cost after transfer by referring to the DC power status table 165 (step S83). For example, the management unit 161 adds the power costs in the before-transfer 165f in the DC power status table 165 as the power cost before transfer. The management unit 161 adds the respective power costs in the after-transfer 165g in the DC power status table 165 as the power cost after transfer.

Then, the management unit 161 returns the calculated power cost before transfer and power cost after transfer and terminates the DC power cost comparison process.

Sequence of Master Storage Transfer Process

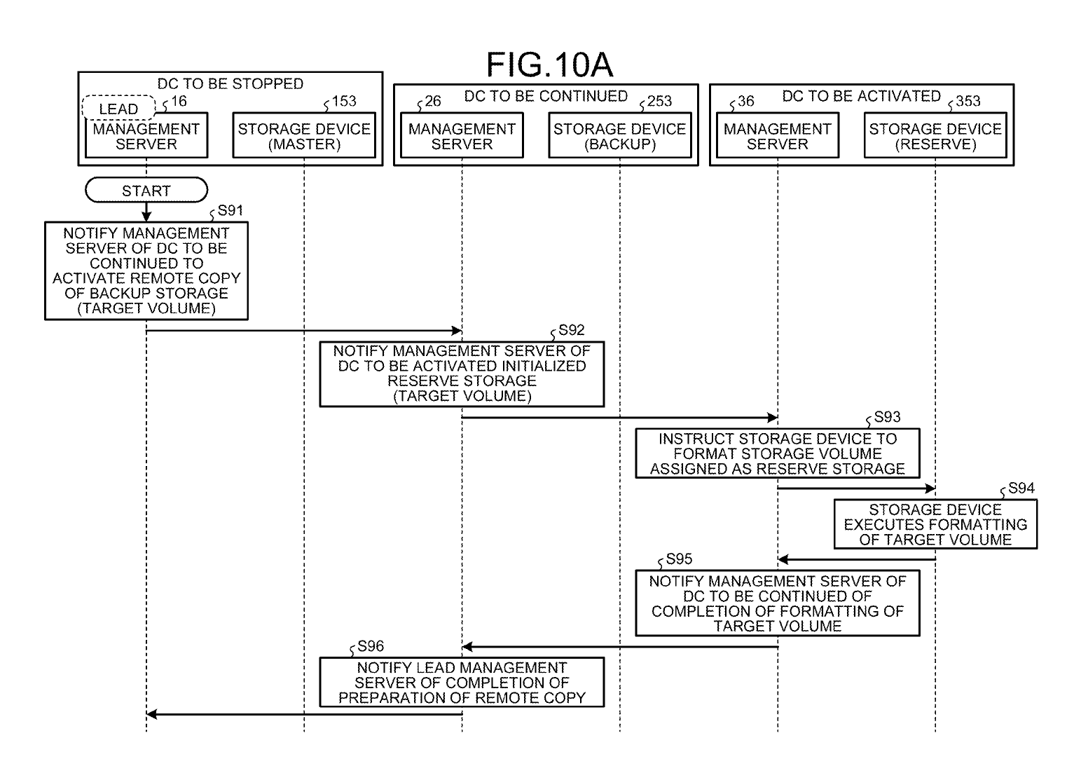

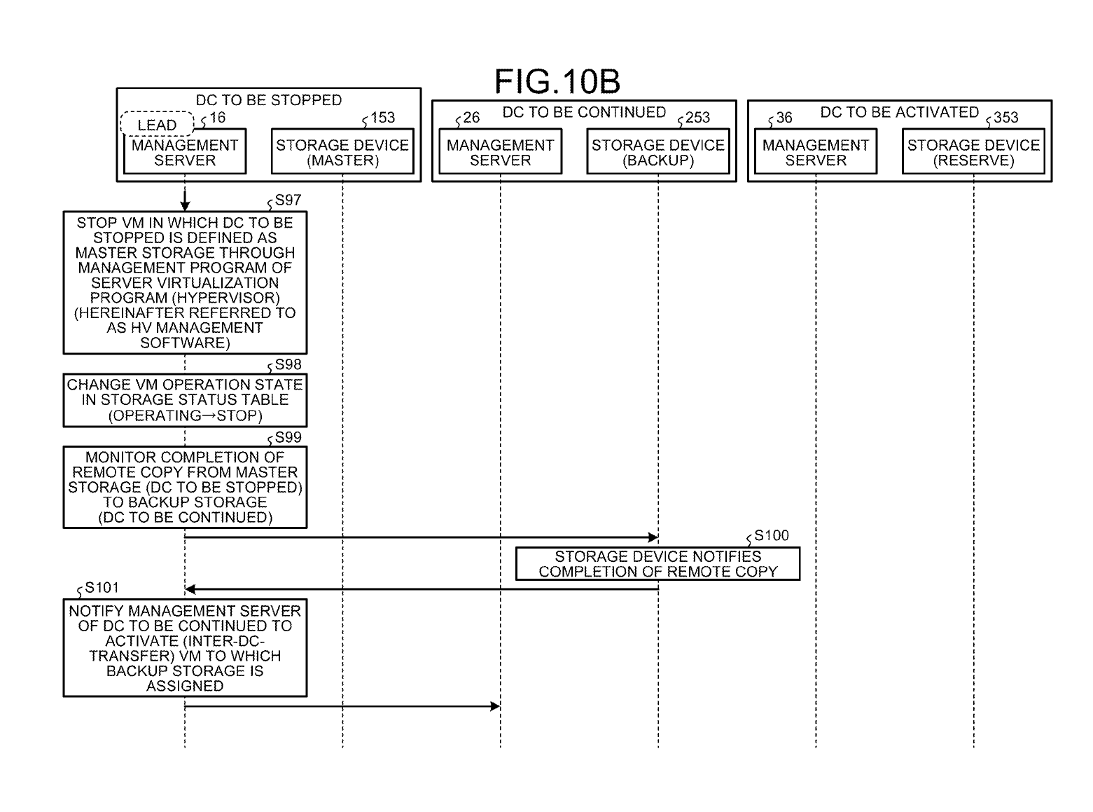

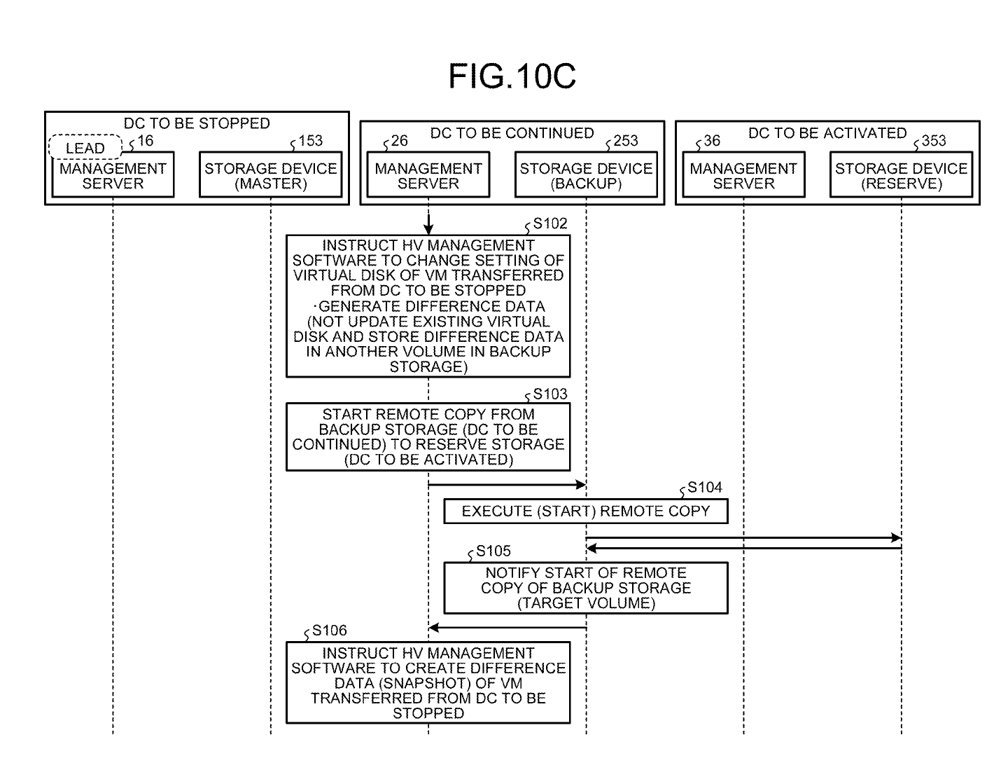

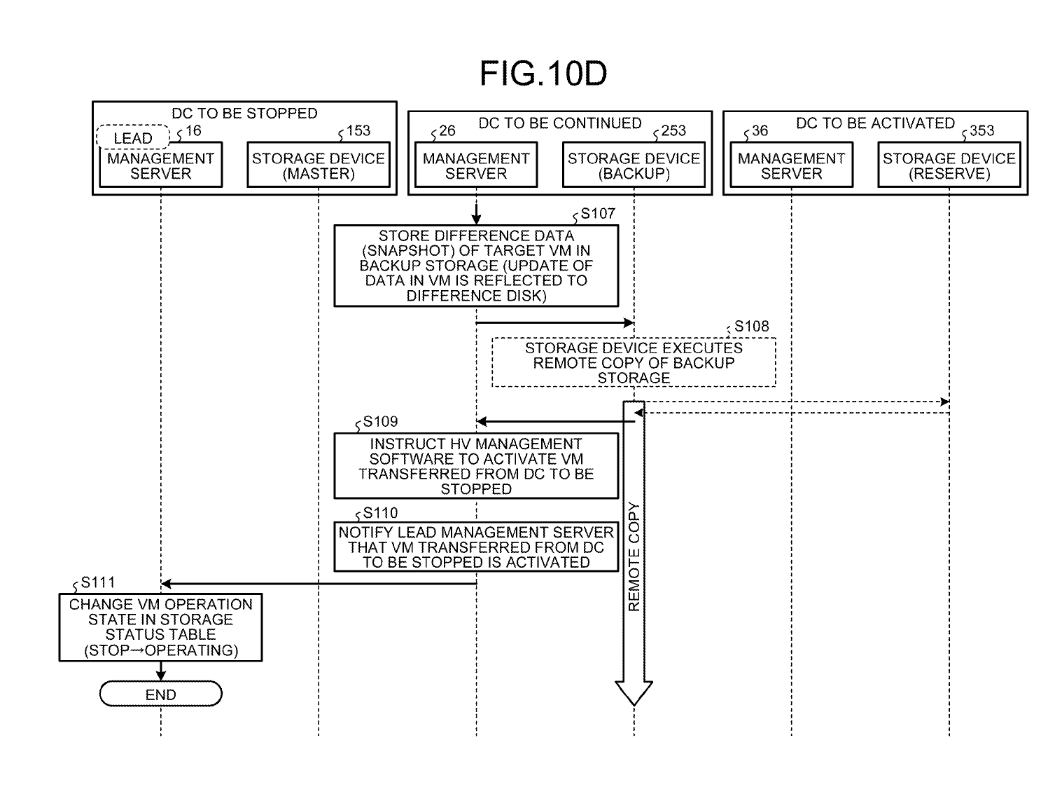

Next, a sequence of the master storage transfer process performed by the management unit 161 will be described with reference to FIGS. 10A to 10D. FIGS. 10A to 10D are diagrams illustrating the sequence of the master storage transfer process. In FIGS. 10A to 10D, as an example, the transfer process of the VM in which the storage role of the Japan DC whose VM operation facility is to be stopped is the master will be described. Therefore, the transfer process of the VM will be described by assuming that the Japan DC is a DC to be stopped, the Germany DC is a DC to be continued, and the USA DC is a DC to be activated. Here, the DC to be stopped means a DC which is currently operating but whose operation is stopped due to sunset. The DC to be continued means a DC which is currently operating and whose operation is continued. The DC to be activated means a DC which is currently stopped but whose operation is started due to sunrise. In FIGS. 10A to 10D, the management server 16 of the Japan DC is the lead. For convenience of description, it is assumed that there is one target VM, and for the target VM, the Japan DC plays the role of the master storage, the Germany DC plays the role of the backup storage, and the USA DC plays the role of the reserve storage.

The management unit 161 notifies the management server 26 of the DC to be continued to start remote copy of the backup storage (backup storage volume 202) (step S91). Then, in the management server 26 of the DC to be continued, the management unit 261 notifies the management server 36 of the DC to be initialized the reserve storage (reserve storage volume 303) (step S92).

In the management server 36 of the DC to be activated, the management unit 361 instructs the storage device 353 to format the reserve storage volume 303 assigned as the reserve storage (step S93). Then, the storage device 353 executes formatting of the reserve storage volume 303 (step S94). Then, the management server 36 notifies the management server 26 of the DC to be continued of the completion of the formatting of the reserve storage volume 303 (step S95).

In the management server 26 of the DC to be continued, the management unit 261 notifies the lead management server 16 of the completion of the preparation of the remote copy (step S96).

In the lead management server 16, the management unit 161 stops the VM in which the DC to be stopped is defined as the master storage through a management program of the hypervisor 152a (hereinafter referred to as HV management software) (step S97). As an example, the HV management software is the hypervisor management unit 161C. For example, the management unit 161 acquires the VM of the DC to be stopped which is defined as the master storage by referring to the storage status table 164. Then, for the DC to be stopped, the management unit 161 changes the operation state 164e corresponding to the VM in the storage status table 164 from “operating” to “stop” (step S98).

Subsequently, the management unit 161 monitors completion of the remote copy from the master storage of the DC to be stopped to the backup storage of the DC to be continued (step S99). In other words, the management unit 161 remotely copies update data in process to the virtual disk of the backup storage volume 202 of the DC to be continued and monitors completion of the remote copy. When the remote copy from the master storage is completed, the storage device 253 of the DC to be continued notifies the completion of the remote copy (step S100).

Subsequently, the management unit 161 notifies the management server 26 of the DC to be continued to activate the VM to which the backup storage is assigned (step S101). In other words, the management unit 161 transfers VM between DCs.

In the management server 26 of the DC to be continued, the management unit 261 notifies the HV management software to change setting of the virtual disk of the VM transferred from the DC to be stopped (step S102). For example, the management unit 261 requests the HV management software to generate a volume to store the difference data. In other words, the management unit 261 stores the I/O processing of the VM to be transferred in another volume in the backup storage volume 202 without updating an existing virtual disk in the backup storage volume 202.

Then, the management unit 261 starts remote copy from the backup storage (DC to be continued) to the reserve storage (DC to be activated) (step S103). Then, the storage device 253 executes (starts) the remote copy (step S104) and notifies the management unit 261 of the start of the remote copy (step S105). The management unit 261 instructs the HV management software to create the difference data (snapshot) of the target VM which is a VM transferred from the DC to be stopped (step S106).

Then, the management unit 261 stores the difference data (snapshot) of the target VM in the backup storage (step S107). In other words, the update of data in the target VM is reflected to a difference disk. When the difference data of the target VM is stored in the backup storage, the storage device 253 executes remote copy from the backup storage (DC to be continued) to the reserve storage (DC to be activated) (step S108).

Subsequently, the management unit 261 instructs the HV management software to activate the VM transferred from the DC to be stopped (step S109). Then, the management unit 261 notifies the lead management server 16 that the VM transferred from the DC to be stopped is activated (step S110).

Then, in the lead management server 16, for the DC to be continued, the management unit 161 changes the operation state 164e corresponding to the VM in the storage status table 164 from “stop” to “operating” (step S111). Then, the management unit 161 terminates the master storage transfer process.

Sequence of Backup Storage Transfer Process

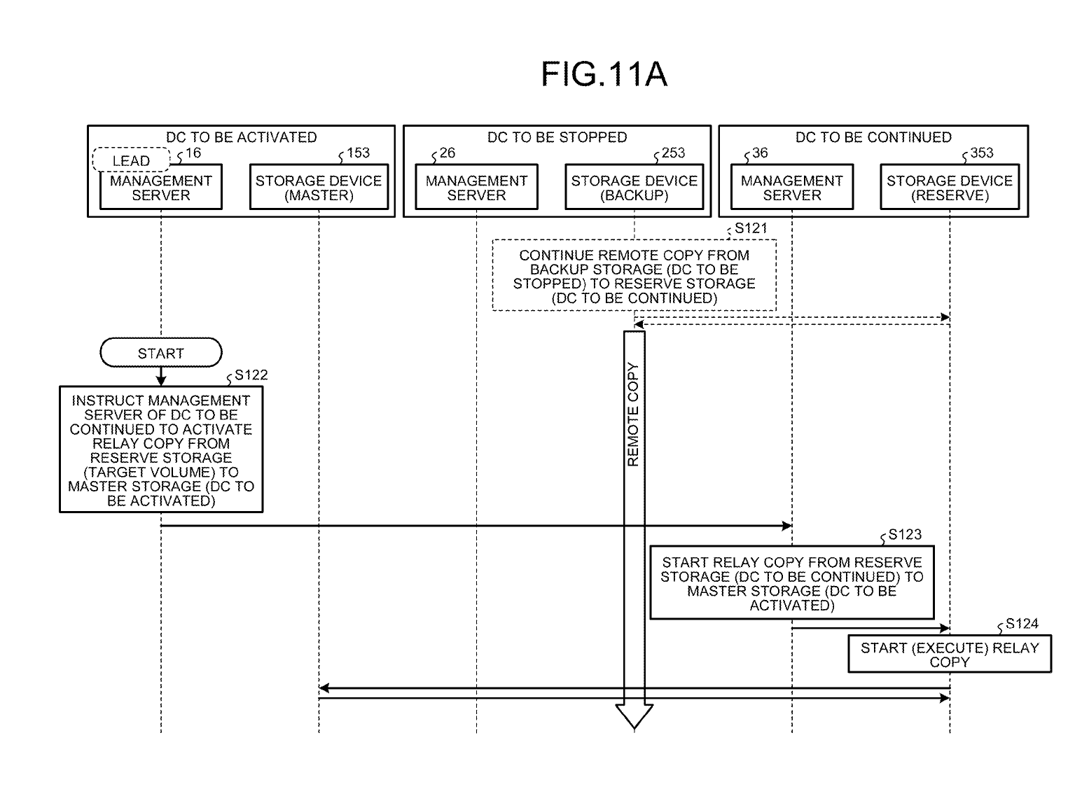

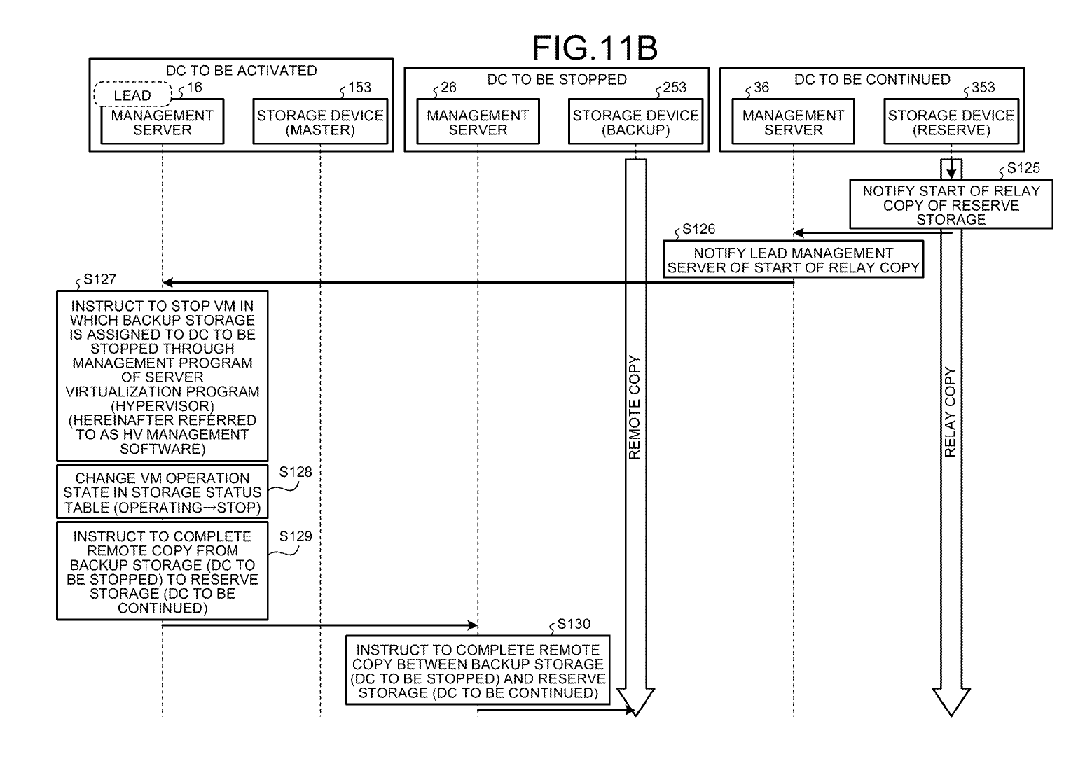

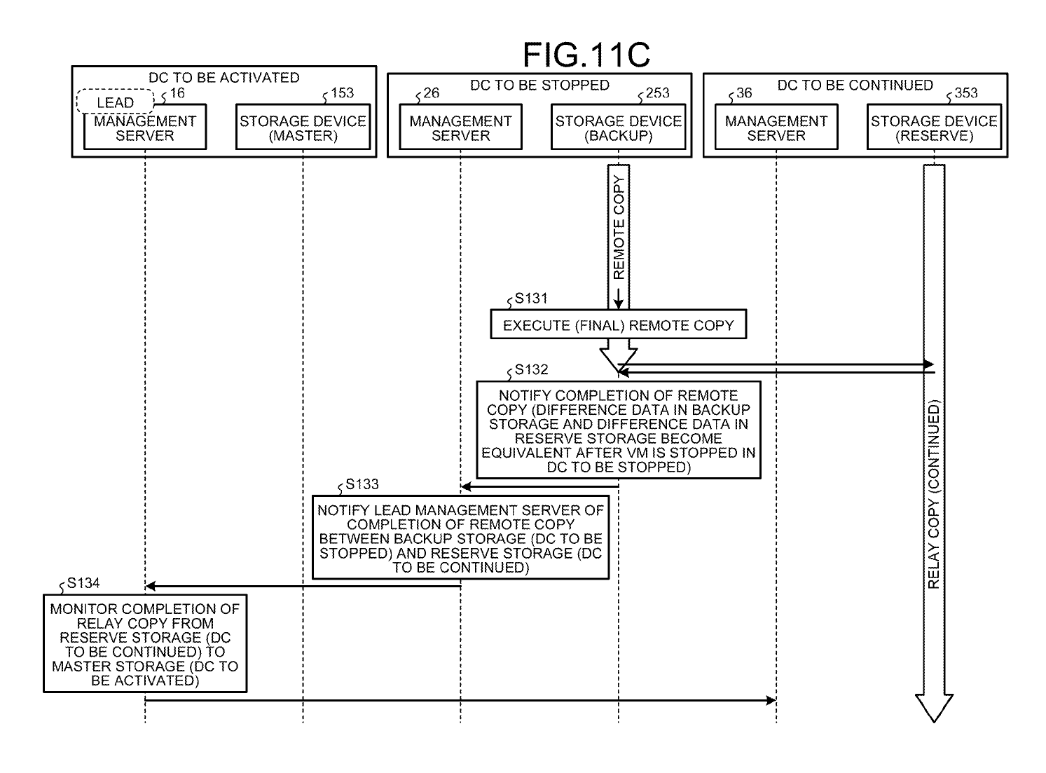

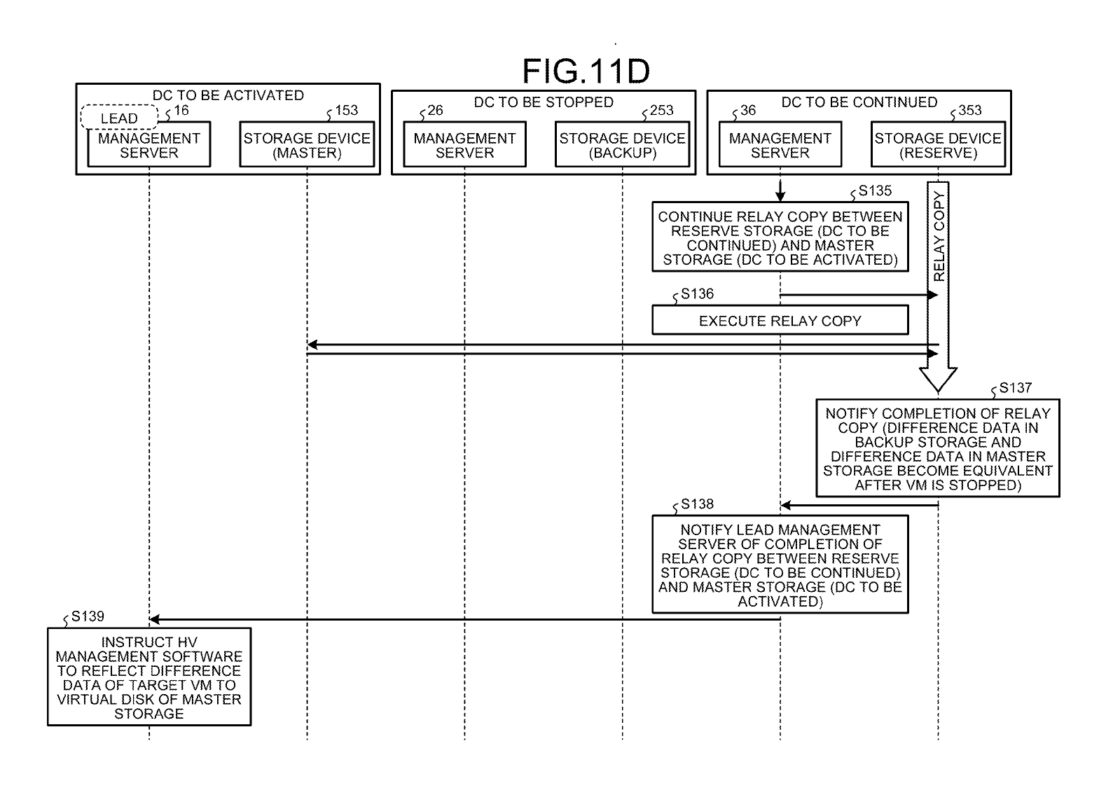

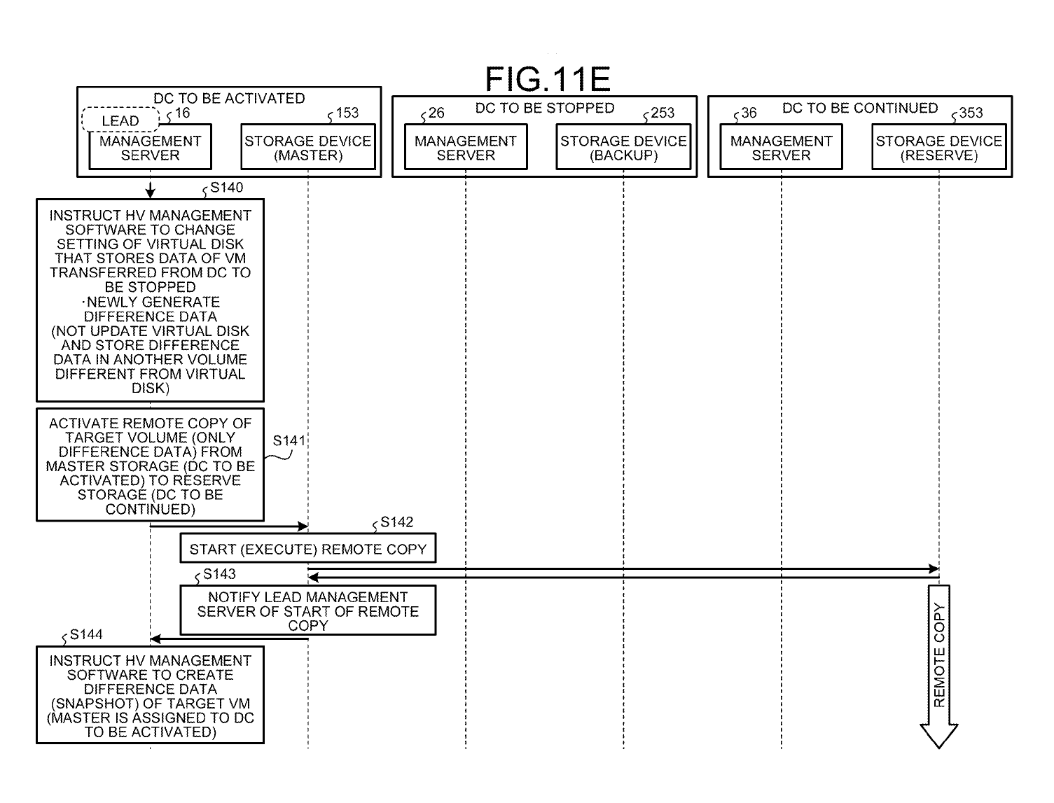

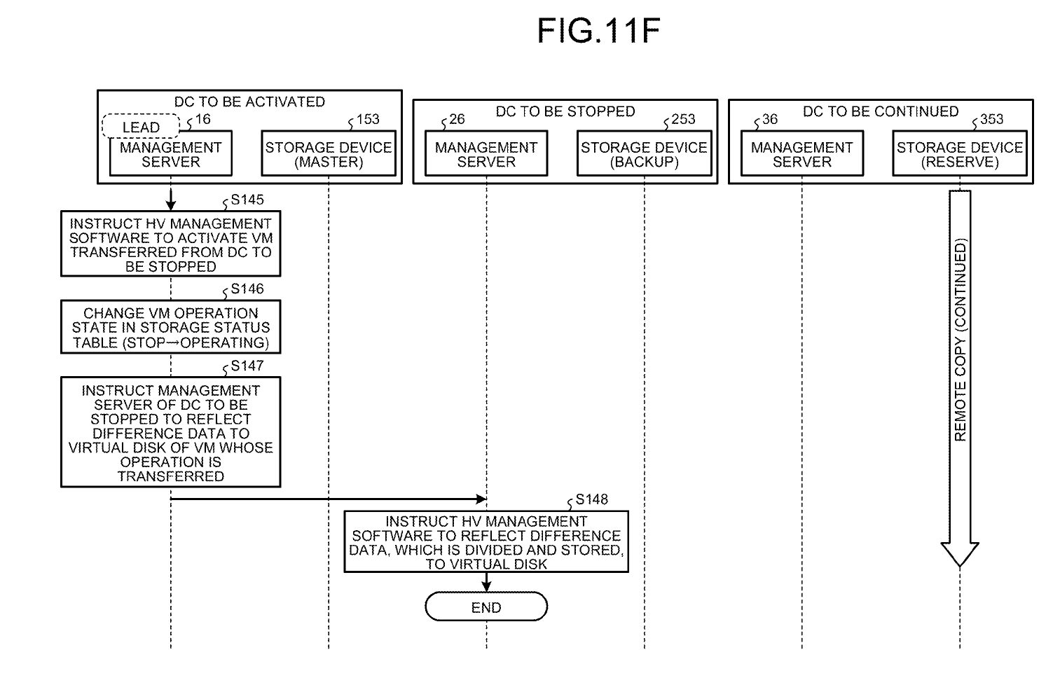

Next, a sequence of the backup storage transfer process performed by the management unit 161 will be described with reference to FIGS. 11A to 11F. FIGS. 11A to 11F are diagrams illustrating the sequence of the backup storage transfer process. In FIGS. 11A to 11F, as an example, the transfer process of the VM in which the storage role of the Japan DC whose VM operation facility is to be stopped is the backup will be described. Therefore, the transfer process of the VM will be described by assuming that the Japan DC is a DC to be activated, the Germany DC is a DC to be stopped, and the USA DC is a DC to be continued. The DC to be stopped means a DC which is currently operating but whose operation is stopped due to sunset. The DC to be continued means a DC which is currently operating and whose operation is continued. The DC to be activated means a DC which is currently stopped but whose operation is started due to sunrise. In FIGS. 11A to 11F, the management server 16 of the Japan DC is the lead. For convenience of description, it is assumed that there is one target VM, and for the target VM, the Japan DC plays the role of the master storage, the Germany DC plays the role of the backup storage, and the USA DC plays the role of the reserve storage.

The storage device 253 continuously executes the remote copy from the backup storage (DC to be stopped) to the reserve storage (DC to be continued) (step S121).

The management unit 161 instructs the management server 36 of the DC to be continued to activate relay copy from the reserve storage (reserve storage volume 303) to the master storage (DC to be activated) (step S122). The “relay copy” here means a sort of remote copy, and in particular, a copy in which the difference data is remotely copied from the reserve storage to the master storage.

In the management server 36 of the DC to be continued, the management unit 361 starts the relay copy from the reserve storage (DC to be continued) to the master storage (DC to be activated) (step S123). Then, the storage device 353 starts (executes) the relay copy (step S124) and notifies the management unit 361 of the start of the relay copy (step S125). Then, the management unit 361 notifies the lead management server 16 of the start of the relay copy (step S126).

In the lead management server 16, the management unit 161 instructs to stop the VM in which the backup storage is assigned to the DC to be stopped by executing the management program of the hypervisor 152a (hereinafter referred to as HV management software) (step S127). For example, the management unit 161 acquires the VM of the DC to be stopped which is defined as the backup storage by referring to the storage status table 164. Then, for the DC to be stopped, the management unit 161 changes the operation state 164e corresponding to the VM in the storage status table 164 from “operating” to “stop” (step S128).

Then, the management unit 161 instructs to complete the remote copy from the backup storage (DC to be stopped) to the reserve storage (DC to be continued) (step S129). Specifically, the management unit 161 instructs the management server 26 of the DC to be stopped to update the final data of the data in process. Then, in the management server 26 of the DC to be stopped, the management unit 261 instructs the storage device 253 to complete the remote copy between the backup storage (DC to be stopped) and the reserve storage (DC to be continued) (step S130).

Then, the storage device 253 executes the (final) remote copy from the backup storage (DC to be stopped) to the reserve storage (DC to be continued) (step S131). As a result, the storage device 353 of the DC to be continued performs relay copy of the remotely copied data from the reserve storage (DC to be continued) to the master storage (DC to be activated).

When the execution of the remote copy is completed, the storage device 253 notifies the management server 26 of the completion of the remote copy (step S132). Thereby, the difference data in the backup storage and the difference data in the reserve storage become equivalent after the VM is stopped in the DC to be stopped. Then, the management server 26 notifies the lead management server 16 of the completion of the remote copy between the backup storage (DC to be stopped) and the reserve storage (DC to be continued) (step S133).

Subsequently, the management unit 161 monitors completion of the relay copy from the reserve storage (DC to be continued) to the master storage (DC to be activated) (step S134). Specifically, the management unit 161 monitors completion of the relay copy of the update data in process which is remotely copied from the backup storage to the reserve storage.

In the management server 36 of the DC to be continued, the management unit 361 continues the relay copy between the reserve storage (DC to be continued) and the master storage (DC to be activated) (step S135) and the storage device 353 executes the relay copy (step S136). Thereafter, the storage device 353 notifies the management server 36 of the completion of the relay copy (step S137). Thereby, the difference data in the backup storage and the difference data in the master storage become equivalent after the VM is stopped in the DC to be stopped. Then, the management unit 361 notifies the lead management server 16 of the completion of the relay copy between the reserve storage (DC to be continued) and the master storage (DC to be activated) (step S138).

Subsequently, in the lead management server 16, the management unit 161 instructs the HV management software to reflect the difference data of the target VM to the virtual disk of the master storage (step S139). Then, the HV management software reflects the relay-copied difference data to the virtual disk which is the virtual disk of the master storage and is redundant with the virtual disk stored in the backup storage.

In the lead management server 16, for the virtual disk of the VM transferred from the DC to be stopped, the management unit 161 notifies the HV management software to change setting of the virtual disk that stores the difference data (step S140). For example, the management unit 161 requests the HV management software to generate a volume to store the difference data. In other words, the management unit 161 stores the I/O processing of the VM to be transferred in another volume in a newly generated master storage without updating an existing virtual disk in the master storage volume 101.

Then, the management unit 161 starts remote copy of a target volume (only the difference data) from the master storage (DC to be activated) to the reserve storage (DC to be continued) (step S141). Then, the storage device 153 starts (executes) the remote copy (step S142) and notifies the lead management server 16 of the start of the remote copy (step S143). In the management server 16, the management unit 161 instructs the HV management software to create the difference data (snapshot) of the target VM which is a VM transferred from the DC to be stopped (step S144).

Subsequently, the management unit 161 instructs the HV management software to activate the VM transferred from the DC to be stopped (step S145). Then, for the DC to be activated, the management unit 161 changes the operation state 164e corresponding to the VM in the storage status table 164 from “stop” to “operating” (step S146).

Subsequently, the management unit 161 instructs the management server 26 of the DC to be stopped to reflect the difference data to the virtual disk of the VM whose operation is transferred (step S147). Then, in the management server 26 of the DC to be stopped, the management unit 261 instructs the HV management software to reflect the difference data of the target VM to the virtual disk of the backup storage (step S148). Thereby, the virtual disk of the backup storage becomes equivalent to the virtual disk of the master storage.

Effect of the Embodiment

According to the embodiment described above, the management server 16 performs management to cause the master storage to hold data as master data and cause the backup storage to hold data equivalent to the master data as backup data. When the data storage destination is switched from the master storage to the backup storage, the management server 16 causes the backup storage to hold update data for the backup data held in the backup storage independently from the backup data. The management server 16 performs management to cause the reserve storage, which is different from the master storage and the backup storage, to duplicate the update data. According to the configuration described above, even when the data storage destination is switched from the master storage to the backup storage, the management server 16 causes the switched storage destination to hold only updated update data in another storage as difference data. As a result, the management server 16 can reduce the total capacity of data while assuring redundancy of data. In other words, the management server 16 can assure redundancy of data even when not holding the same capacity of data for the three storages.

According to the embodiment described above, when the data storage destination is switched from the backup storage to the master storage, the management server 16 performs management to cause the master storage to duplicate the update data duplicated in the reserve storage. According to the configuration described above, even when the data storage destination is switched from the backup storage to the master storage, the management server 16 causes the master storage to duplicate only the update data duplicated in the reserve storage. As a result, the management server 16 can assure redundancy of data in the backup storage and the master storage and further can reduce the total capacity of data.

According to the embodiment described above, the management server 16 manages data of VM for the master storage, the backup storage, and the reserve storage, which are assigned to a transferable VM in advance. According to the configuration described above, when each storage is assigned to the transferable VM, the management server 16 can assure redundancy of data of the VM and further can reduce the total capacity of data.

According to the embodiment described above, the management server 16 assigns the master storage, the backup storage, and the reserve storage to a plurality of transferable VMs in advance. According to the configuration described above, the management server 16 can assure redundancy of data of VMs and further can reduce the total capacity of data.

According to the embodiment described above, the management server 16 causes the master storage of the DC 1 to hold data of the VM being operated in a first DC 1 as master data. The management server 16 performs management to cause the backup storage of the DC 2 to hold data equivalent to the master data as backup data. When the data storage destination is switched from the master storage to the backup storage for the VM being operated in the DC 2, the management server 16 causes the backup storage to hold update data for the backup data held in the backup storage independently from the backup data. The management server 16 performs management to cause the reserve storage, which is different from the master storage and the backup storage, to duplicate the update data. According to the configuration described above, even when the data storage destination is switched from the master storage to the backup storage, the management server 16 causes the switched storage destination to hold only updated update data in another storage as difference data. As a result, the management server 16 can reduce the total capacity of data of the DCs 1, 2, and 3 while assuring redundancy of data for the VM of the DCs 1, 2, and 3. In other words, the management server 16 can assure redundancy of data even when not holding the same capacity of data for the three storages of the DCs 1, 2, and 3.

According to the embodiment described above, the management server 16 calculates the power cost of each DC. The management server 16 determines whether or not the power cost of the DC in which VM is being operated is higher than the power cost of a transfer destination DC in a case in which the VM is transferred, on the basis of each calculated power cost. As a result of the determination, when it is determined that the power cost of the DC in which the VM is being operated is higher than the power cost of the transfer destination DC in a case in which the VM is transferred, the management server 16 switches the storage destination of the data of the VM from the DC in which the VM is being operated to the transfer destination DC. When the data storage destination is switched, the management server 16 performs management to cause the backup storage to hold update data for the backup data independently from the backup data and cause the reserve storage to duplicate the update data. According to the configuration described above, the management server 16 switches the storage destination of data of the VM to a DC whose power cost is not high among the DCs, so that it is possible to reduce the total power cost.

Others

In the embodiment, it is described that the information processing system 9 includes a plurality of data centers and the plurality of data centers are installed in A country, B country, and C country, respectively. However, the information processing system 9 is not limited to this. In other words, the plurality of data centers may be installed in the same country and only have to be installed respectively in regions whose daylight hours are different from each other, that is, regions whose power costs are different from each other at that same time point.

Further, in the embodiment, the management unit 161 manages data between DCs when the data storage destination is switched according to transfer of the VM between the DCs. Specifically, the first management unit 161b updates data of the VM being operated in the DC 1 as master data into the master storage volume 101 in the DC 1. Then, the first management unit 161b remotely copies the updated data as backup data into the backup storage volume 202 of the DC 2 having data equivalent to the data before the update for the VM. When the data storage destination is switched from the master storage volume 101 of the DC 1 to the backup storage volume 202 of the DC 2, the second management unit 161d stops the operation of the VM operation facility 15 of the DC 1 and transfers the VM from the DC 1 to the DC 2. The second management unit 161d causes an area independent from the backup data in the backup storage volume 202 to hold the update data for the backup storage volume 202 of the DC 2 as the difference data. Then, the second management unit 161d causes the reserve storage volume 303 of the DC 3 to remotely copy the update data as the reserve data. However, the management unit 161 is not limited to this, and the management unit 161 need not correspond to the transfer of the VM between the DCs but may manage data when the data storage destination is switched by a predetermined condition. For example, the first management unit 161b updates data accessed by a host as master data into the master storage volume 101 in the storage device 153. Then, the first management unit 161b remotely copies the updated data as backup data into the backup storage volume 102 in the same storage device 153 having data equivalent to the data before the update. When the data storage destination is switched from the master storage volume 101 to the backup storage volume 102 by a predetermined condition, the second management unit 161d causes an area independent from the backup data in the backup storage volume 102 to hold the update data for the backup storage volume 102 as the difference data. Then, the second management unit 161d causes the reserve storage volume 103 in the same storage device 153 to remotely copy the update data as the reserve data. Thereby, the management server 16 can reduce the total capacity of data while assuring redundancy of data. In other words, the management server 16 can assure redundancy of data even when not holding the same capacity of data for the three storages.

Each component of the data center 1 illustrated in the drawings need not necessarily be physically configured as illustrated in the drawings. In other words, specific forms of distribution and integration of the data center 1 are not limited to those illustrated in the drawings, and all or part of the data center 1 can be functionally or physically distributed or integrated in arbitrary units according to various loads and the state of use. For example, the first management unit 161b, the second management unit 161d, and the third management unit 161e may be integrated into one management unit. Further, the second management unit 161d may be distributed into a transfer management unit that transfers VM, a holding management unit that causes the backup storage to hold the update data, and a duplication management unit that causes the reserve storage to duplicate the update data. The data centers 2 and 3 are the same as the data center 1.

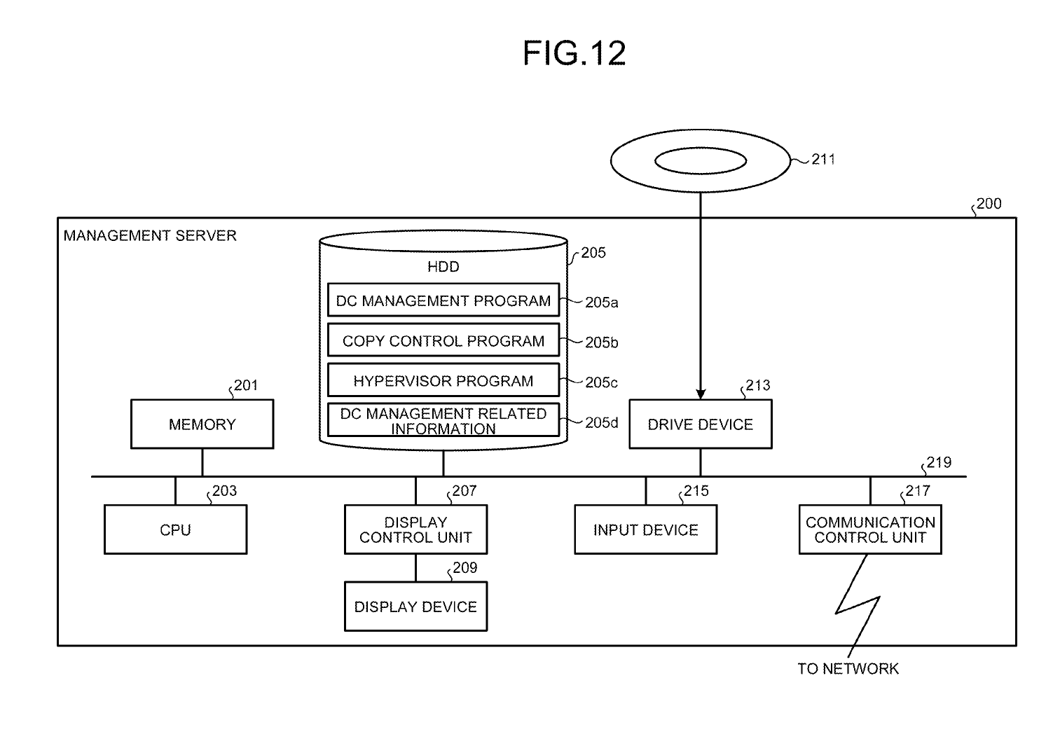

In the embodiment, when the function held by the management server 16 is realized by software, the management unit 161 having the same function can be obtained. Therefore, an example of a computer that executes the DC management program having the same function as that of the management server 16 illustrated in FIG. 2A will be described below. FIG. 12 is a diagram illustrating an example of a management server that executes the DC management program.

As illustrated in FIG. 12, a management server 200 includes a CPU 203 that executes various arithmetic operations, an input device 215 that receives input of data from a user, and a display control unit 207 that controls a display device 209. The management server 200 further includes a drive device 213 that reads a program and the like from a storage medium and a communication control unit 217 that transmits and receives data to and from the storage device 153 and other computers through a network. The management server 200 further includes a memory 201 that temporarily stores various pieces of information and an HDD 205. The memory 201, the CPU 203, the HDD 205, the display control unit 207, the drive device 213, the input device 215, and the communication control unit 217 are connected by a bus 219.

The drive device 213 is, for example, a device for a portable storage medium such as a removable disk 211. The HDD 205 stores a DC management program 205a, a copy control program 205b, a hypervisor program 205c, and DC management related information 205d.

The CPU 203 reads the DC management program 205a, the copy control program 205b, and the hypervisor program 205c, develops the programs in the memory 201, and executes the programs as processes. The processes correspond to each functional unit of the management unit 161. The DC management related information 205d corresponds to the storage status table 164, the DC power status table 165, and the DC basic power amount table 166. For example, the removable disk 211 stores each piece of information such as the storage status table 164.

The DC management program 205a, the copy control program 205b, and the hypervisor program 205c need not necessarily be stored in the HDD 205 from the beginning. For example, the programs are stored in a “portable physical medium” such as a flexible disk (FD), a CD-ROM, a DVD disk, a magneto-optical disk, and an IC card, which are inserted into the management server 200. The management server 200 may read the DC management program 205a, the copy control program 205b, and the hypervisor program 205c from the “portable physical medium” and execute the programs.

According to an aspect of the storage management device disclosed by the present application, it is possible to reduce the total capacity of data stored in a storage while assuring redundancy of the storage for the virtual machine.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage management device comprising:
a memory; and
a processor coupled to the memory, wherein the processor executes a process including:
managing a plurality of storages in a system in which a data storage destination is switched between a first storage and a second storage;
first performing management to cause the first storage to hold data as master data and cause the second storage to hold data equivalent to the master data as backup data; and
second performing management to cause the second storage to hold update data for the backup data held in the second storage independently from the backup data and cause a third storage different from the first storage and the second storage to duplicate the update data when the data storage destination is switched from the first storage to the second storage.

2. The storage management device according to claim 1, wherein the process further includes third performing management to cause the first storage to duplicate the update data duplicated by the third storage when the data storage destination is switched from the second storage to the first storage.

3. The storage management device according to claim 1, wherein the process further includes assigning the first storage, the second storage, and the third storage as a storage destination of the master data, a storage destination of the backup data, and a storage destination of the update data, for the data.

4. The storage management device according to claim 1, wherein
the managing includes managing a plurality of storages that stores data of a virtual machine that is able to be transferred between a first data center and a second data center,
the first performing includes performing management to cause the first storage of the first data center to hold data of the virtual machine being operated in the first data center as master data and cause the second storage of the second data center to hold data equivalent to the master data as backup data, and
the second performing includes performing management to cause the second storage to hold update data for the backup data held in the second storage independently from the backup data and cause a third storage different from the first storage and the second storage to duplicate the update data when the data storage destination is switched from the first storage to the second storage for the virtual machine being operated in the second data center.

5. The storage management device according to claim 4, wherein the process further includes assigning the first storage, the second storage, and the third storage as a storage destination of the master data, a storage destination of the backup data, and a storage destination of the update data, for data of a plurality of transferable virtual machines.

6. The storage management device according to claim 4, wherein the process further includes:
calculating a power cost of each data center; and
determining whether or not a power cost of a data center in which the virtual machine is being operated is higher than a power cost of a transfer destination data center in a case in which the virtual machine is transferred, based on each power cost calculated at the calculating, wherein
when it is determined that the power cost of the data center in which the virtual machine is being operated is higher than the power cost of the transfer destination data center in a case in which the virtual machine is transferred, the second performing includes performing management to switch a data storage destination of data of the virtual machine from the data center in which the virtual machine is being operated to the transfer destination data center, and when the data storage destination is switched, the second performing includes performing management to cause the second storage to hold update data for the backup data independently from the backup data and cause the third storage to duplicate the update data.

7. An information processing system comprising:
a first data center; and
a second data center, wherein
a storage management device, which is a storage management device of either one of the first data center and the second data center, includes:
a memory; and
a processor coupled to the memory, wherein the processor executes a process including:
managing a plurality of storages that stores data of a virtual machine that is able to be transferred between the first data center and the second data center;
first performing management to cause a first storage of the first data center to hold data of the virtual machine being operated in the first data center as master data and cause a second storage of the second data center to hold data equivalent to the master data as backup data; and
second performing management to cause the second storage to hold update data for the backup data held in the second storage independently from the backup data and cause a third storage different from the first storage and the second storage to duplicate the update data when a data storage destination is switched from the first storage to the second storage for the virtual machine being operated in the second data center.

8. A non-transitory computer-readable recording medium having stored therein a program that causes a computer to execute a storage management process comprising:
managing a plurality of storages in a system in which a data storage destination is switched between a first storage and a second storage;
first performing management to cause the first storage to hold data as master data and cause the second storage to hold data equivalent to the master data as backup data; and
second performing management to cause the second storage to hold update data for the backup data held in the second storage independently from the backup data and cause a third storage different from the first storage and the second storage to duplicate the update data when the data storage destination is switched from the first storage to the second storage.
